(19) United States
(12) Patent Application Publication
(10) Pub. No.: US 2024/0116083 A1
(43) Pub. Date: Apr. 11, 2024

(54) METHODS OF SORTING MATTHIOLA SEEDS

(71) Applicants: SeedX Technologies Inc., Wilmington, DE (US); Sakata Holland B.V., Hoofddorp (NL)

(72) Inventors: Sharon AYAL, Kibbutz Bet Nir (IL); Elad CARMON, Petach-Tikva (IL); Paulus Bernardus Hendrikus HENDRIKX, Bovenkarspel (NL)

(73) Assignees: SeedX Technologies Inc., Wilmington, DE (US); Sakata Holland B.V., Hoofddorp (NL)

(21) Appl. No.: 18/539,404

(22) Filed: Dec. 14, 2023

Related U.S. Application Data
(63) Continuation of application No. PCT/IB2022/055573, filed on Jun. 16, 2022.
(60) Provisional application No. 63/211,029, filed on Jun. 16, 2021.

(30) Foreign Application Priority Data
Jun. 16, 2021 (NL) 2028466

(51) Int. Cl. B07C 5/342; G06V 10/74; G06V 10/762; G06V 10/764; G06V 10/82; G06V 20/60

(52) U.S. Cl. CPC B07C 5/3425; G06V 10/761; G06V 10/762; G06V 10/764; G06V 10/82; G06V 20/60

(57) ABSTRACT

Systems for sorting of Matthiola seeds are disclosed on the basis of a single flower/double flower phenotype. Collections of sorted seeds are also disclosed.

### RELATED APPLICATIONS

This application is a Continuation of PCT Patent Application No. PCT/IB2022/055573 having International filing date of Jun. 16, 2022 which claims the benefit of priority of Netherlands Patent Application No. 2028466 and under 35 USC § 119(e) of U.S. Provisional Patent Application No. 63/211,029, both filed on Jun. 16, 2021. The contents of the above applications are all incorporated by reference as if fully set forth herein in their entirety.

### FIELD AND BACKGROUND OF THE INVENTION

The present invention, in some embodiments thereof, relates to a method of distinguishing between a single flower phenotype and a double flower phenotype of Matthiola seeds and, more particularly, but not exclusively, to Matthiola incana, seeds.

Matthiola incana belongs to the family Brassicaceae and is a species of flowering plant of the genus Matthiola. Common names include Brompton stock, common stock, hoary stock, ten-week stock and gilly-flower.

The Matthiola incana flower is widely used as an ornamental plant during the summer season and as a cut flower or aromatic plant throughout the year. The flowers can be simple or filled, medium or large. There are many Matthiola incana varieties with different flower colors, including white, yellow, pink, rose, red, marine, blue, purple.

Matthiola incana seeds segregate between two flower phenotypes, double flower and single flower. Double-flowered varieties are an important ornamental plant and are commercially advantageous over single flowers varieties but are sterile. Lacking reproductive organs these double-flowering do not produce seeds, since the reproductive organs have been replaced by petals.

They therefore must be produced from the seed of single-flowered plants. The double-flowered form is caused by a recessive gene variant (allele) in the homozygous condition. Therefore, according to the Mendelian laws of genetics, heterozygous single-flowered stocks should produce one-quarter doubles in their offspring and one third of the singles should be pure breeding singles incapable of throwing doubles.

Selection over the centuries has greatly improved these ratios, resulting in the so-called “ever-sporting” stocks, in which pure-breeding singles are absent and the proportion of doubles is one half or greater. In these varieties, the singleness allele is closely linked to a pollen-lethal gene. Thus, the pollen (male) contribution to seed is always a doubleness allele, while the female contribution is either a doubleness or a singleness allele. The result of this linkage is that doubles and singles are produced in 50:50 ratios and there are no pure-breeding singles, if it is assumed that chromosome crossing/recombination does not occur. However, it is generally known that the crossing/recombination occurs with a frequency of 1% or less.

Furthermore, many modern strains produce doubles in even higher proportions: 60% or even 92%. This is due to generations of selection for further linked viability effects, producing higher mortality of heterozygous singles, relative to homozygous doubles.

The double-flowering trait of Matthiola incana corresponds to the s locus. The gene responsible for double flowers has been identified and DNA markers have been developed. However, using these DNA markers for selection of single- or double-flowered individuals among seeds or seedlings is extremely labor intensive and costly and does not offer any opportunity to select larger quantities of seeds or seedlings for single or double flowering plants.

Within Matthiola incana (which exhibit double-flowering plants) different groups of varieties can be distinguished from one another based on their genetic background and morphological traits. Many of these varieties have a particular morphological trait which can be used to select for double-flowering plants. To obtain double-flowering plants, breeders and multipliers have relied on the correlation between double flowers and morphological traits, such as cotyledon shape, cotyledon color, serrated leaf, germination speed, seed color and leaf color. However, this form of selection can be extremely labor intensive and does require in some cases highly skilled labor.

Background art includes WO2019/106641, WO2019/106638 and WO2019/106639.

### SUMMARY OF THE INVENTION

According to an aspect of the present invention there is provided a system for sorting of Matthiola seeds, comprising:

at least one hardware processor executing a code for:

feeding into at least one neural network, at least one image depicting a plurality of Matthiola seeds which have statistically similar extractable at least one visual feature, the at least one image captured by at least one imaging sensor,

wherein the at least one visual feature extracted from an image of one of the plurality of Matthiola seeds are statistically similar to corresponding at least one visual feature extracted from another image of another Matthiola seed of the plurality of Matthiola seeds,

computing by the at least one neural network, an indication of one classification category for which visual features are not explicitly defined, for each of the plurality of Matthiola seeds selected from the group consisting of: single flowering, and double flowering,

wherein the indication of at least one classification category is computed at least according to weights of the at least one neural network,

wherein the at least one neural network classifies the plurality of Matthiola seeds which have similar extractable at least one visual feature into one classification category selected from the group consisting of: flowering, and double flowering for which visual features are not explicitly defined,

wherein the at least one neural network is trained using a training dataset comprising a plurality of training images of a plurality of seeds which have statistically similar extractable at least one visual feature captured by the at least one imaging sensor, each Matthiola seed of each training image labelled with a respective classification category for which visual features are not explicitly defined selected from the group consisting of: single flowering and double flowering; and

generating according to the indication of at least one classification category selected from the group consisting of: single flowering and double flowering, instructions for execution by a sorting controller of an automated sorting device for automated sorting of Matthiola seeds. According to an aspect of the present invention there is provided a system for classification of Matthiola seeds, comprising:

at least one hardware processor executing a code for: feeding into at least one neural network, at least one image depicting a plurality of Matthiola seeds which have statistically similar extractable at least one visual feature, the at least one image captured by at least one imaging sensor,

wherein the at least one visual feature extracted from an image of one of the plurality of Matthiola seeds are statistically similar to corresponding at least one visual feature extracted from another image of another Matthiola seed of the plurality of Matthiola seeds; and

computing by the at least one neural network, an indication of one classification category for which visual features are not explicitly defined, for each of the plurality of Matthiola seeds selected from the group consisting of: single flowering, and double flowering,

wherein the indication of at least one classification category is computed at least according to weights of the at least one neural network,

wherein the at least one neural network classifies the plurality of Matthiola seeds which have similar extractable at least one visual feature into one classification category selected from the group consisting of: flowering, and double flowering for which visual features are not explicitly defined,

wherein the at least one neural network is trained using a training dataset comprising a plurality of training images of a plurality of Matthiola seeds which have statistically similar extractable at least one visual feature captured by the at least one imaging sensor, each Matthiola seed of each training image labelled with a respective classification category for which visual features are not explicitly defined selected from the group consisting of: single flowering and double flowering.

According to an aspect of the present invention there is provided a device for training at least one neural network for classification of Matthiola seeds for sorting thereof, comprising:

at least one hardware processor executing a code for:

accessing a plurality of training images of a plurality of Matthiola seeds which have statistically similar extractable at least one visual feature captured by at least one imaging sensor,

wherein the at least one visual feature extracted from an image of one of the plurality of Matthiola seeds are statistically similar to corresponding at least one visual feature extracted from another image of another Matthiola seed of the plurality of Matthiola seeds;

creating a training dataset by labeling each Matthiola seed of each training image with a respective classification category for which visual features are not explicitly defined selected from a group consisting of: single flowering and double flowering,

wherein each label is determined by growing the respective Matthiola seed after the respective training image of the Matthiola seed is captured by the at least one imaging sensor until the single flower or double flower is visually present; and

training at least one neural network using the training dataset, the at least one neural network trained for generating an outcome of an indication of one classification category for which visual features are not explicitly defined, selected from the group consisting of: single flowering and double flowering, in response to an input of at least one target image depicting at least one seed captured by at least one imaging sensor,

wherein the indication of at least one classification category of the at least one target image is computed at least according to weights of the at least one trained neural network,

wherein the at least one neural network classifies the plurality of Matthiola seeds which have similar extractable at least one visual feature into one classification category selected from the group consisting of: single flowering and double flowering, for which visual features are not explicitly defined.

According to an aspect of the present invention there is provided a container comprising a plurality of Matthiola seeds, wherein at least 90% of the seeds are double flowering seeds, and wherein the plurality of Matthiola seeds comprises more than 100 seeds.

According to an aspect of the present invention there is provided a container comprising a plurality of Matthiola seeds, wherein at least 90% of the seeds are single flowering seeds, and wherein the plurality of Matthiola seeds comprises more than 100 seeds.

According to an aspect of the present invention there is provided a method of growing a crop comprising seeding the seeds of the container described herein, thereby growing the crop.

According to an aspect of the present invention there is provided a method of classifying Matthiola seeds, comprising: growing unclassified Matthiola seeds, capturing at least one image of the Matthiola seeds, and classifying respective the Matthiola seeds into a specific classification category selected from a plurality of classification categories according to an outcome of a trained neural network model fed with the at least one image.

According to another aspect of the present invention there is provided a method of classifying Matthiola seeds, comprising:

capturing at least one image of the Matthiola seeds; and

classifying respective the Matthiola seeds into a specific classification category selected from a plurality of classification categories according to an outcome of a trained neural network model fed with the at least one image.

According to embodiments of the present invention, visual features extracted from the plurality of Matthiola seeds depicted in the at least one image include only statistically similar extractable features and exclude non-statistically similar extractable visual features.

According to embodiments of the present invention, non-statistically similar visual features extracted from the plurality of Matthiola seeds depicted in the at least one image are non-correlated with the classification category outcome of the at least one neural network selected from the group consisting of: single flowering and double flowering.

According to embodiments of the present invention, the non-statistically similar visual features extracted from the plurality of Matthiola seeds depicted in the at least one image include a segmented visual marker, the segmented visual marker being non-correlated with the classification category selected from the group consisting of: single flowering and double flowering.

According to embodiments of the present invention, the similar extractable at least one visual feature is selected from the group consisting of: a hand-crafted feature, at least one size dimension of the at least one seed, color of the at least one seed, shape of the at least one seed, texture of the at least one seed, estimated measurement of the at least one seed, and segmented visual marker.

According to embodiments of the present invention, the at least one classification category comprises a non-visual category that cannot be manually determined based on visual inspection of the at least one seed.

According to embodiments of the present invention, the Matthiola seeds are of the species Matthiola incana.

According to embodiments of the present invention, the Matthiola incana seeds are of the Iron series.

According to embodiments of the present invention, the at least one classification category is determined by a destructive test that destroys the respective Matthiola seed after the respective training image of the Matthiola seed is captured by the at least one imaging sensor.

According to embodiments of the present invention, the label at least one classification category is determined by growing the respective Matthiola seed after the respective training image of the Matthiola seed is captured by the at least one imaging sensor until the single flower or double flower is visually present.

According to embodiments of the present invention, the imaging sensor is selected from the group consisting of: RGB, multispectral, hyperspectral, visible light frequency range, near infrared (NIR) frequency range, infrared (IR) frequency range, and combinations of the aforementioned.

According to embodiments of the present invention, the at least one image including at least one Matthiola seed comprises a single image of a single Matthiola segmented from an image including a plurality of Matthiola seeds.

According to embodiments of the present invention, the at least one neural network computes an embedding for the at least one image, and wherein the at least one classification category is determined according to an annotation of an identified at least one similar embedded image from the training dataset storing embeddings of training images, the at least one similar embedded image identified according to a requirement of a similarity distance between the embedding of the at least one image and embedding of the training images, and at least one member selected from the group consisting of: (i) wherein the embedding is computed by an internal layer of the trained at least one neural network selected as an embedding layer, (ii) wherein the embedding is stored as a vector of a predefined length, wherein the similarity distance is computed as a distance between a vector storing the embedding of the at least one image and a plurality of vectors each storing embedding of respective training images, and (iii) wherein the similarity distance is computed between the embedding of the at least one image and a cluster of embeddings of a plurality of training images each associated with a same at least one classification category.

According to embodiments of the present invention, the at least one image comprises a plurality of images including a plurality of Matthiola seeds, and further comprising code for clustering the plurality of images according to respective classification categories, wherein the instructions for execution by the sorting controller comprise instructions for sorting the Matthiola seeds corresponding to the plurality of images according to respective classification categories, wherein the clusterization is performed according to a target ratio of classification categories and/or a target statistical distribution, wherein members of the clusters are arranged according to the target ratio, the target ratio of classification categories is computed according to a DNA analysis of a sample of the Matthiola seeds, or according to a growth outcome of planting and growing the sample of the Matthiola seeds.

According to embodiments of the present invention, the clusters of different classification categories are created for at least one member selected from the group consisting of: (i) Matthiola seeds are grown under same environmental conditions, (ii) Matthiola seeds are grown at a same growing season, (iii) Matthiola seeds are grown at a same geographical location, and (iv) Matthiola seeds having identical physical parameters within a tolerance range.

According to embodiments of the present invention, a non-neural network based statistical classifier trained for extraction of the at least one visual feature classifies the plurality of Matthiola seeds which have similar extractable at least one visual feature into a same classification category for which visual features are explicitly defined.

According to embodiments of the present invention, the at least one image comprises a plurality of images including a plurality of Matthiola seeds of different classification categories, wherein the at least one neural network computes an embedding for each of the plurality of images, wherein the embedding of the plurality of images are clustered by clusterization code, and wherein the instructions for execution by the sorting controller comprise instructions for sorting the Matthiola seeds according to corresponding clusters.

According to embodiments of the present invention, the clusters are computed according to at least one member selected from the group consisting of:

(i) such that each embedded image member of each respective cluster is at least a threshold distance away from another cluster, and

(ii) wherein the clusters are computed such that each embedded image member of each respective cluster is less than a threshold distance away from every other member of the same respective cluster.

According to embodiments of the present invention, an intra-cluster distance computed between embeddings of a same cluster is less than an inter-cluster distance computed between embeddings of different clusters.

According to embodiments of the present invention, the Matthiola seeds corresponding to embeddings located above a distance threshold from at least one of: another embedding, a cluster, and within a center of the cluster, are denoted as being of a certain color and clustered into a certain color cluster, wherein Matthiola seeds denoted as being of a certain color are assigned a new classification category or to a new sub-classification category of the existing category according to classification categories assigned to at least two image embeddings and/or at least two clusters in proximity to the embedding of the Matthiola seed denoted as being of a certain color, wherein the new classification category or new sub-classification of existing category is computed according to relative distances to the at least two image embeddings and/or at least two clusters in proximity to the embedding of the Matthiola seed denoted as being of a certain color.

According to embodiments of the present invention, at least one statistical value is computed for each cluster, and wherein a certain Matthiola seed is denoted as being defective when the embedding of the image of the certain seed is statistically different from all other clusters.

According to embodiments of the present invention, at least one statistical value is computed for each cluster, and wherein a certain seed is assigned a certain classification category of a certain cluster when the embedding of the image of the certain seed is statistically similar to at least one statistical value of the certain cluster.

According to embodiments of the present invention, the system further comprises code for: providing an image of a target Matthiola seed, computing the embedding of the target Matthiola seed by the at least one neural network, and

selecting a sub-set of the plurality of image embeddings according to image embedding located less than a target distance threshold away from the embedding of the target Matthiola seed, wherein the instructions for execution by the sorting controller comprise instructions for selecting Matthiola seeds corresponding to the sub-set of the plurality of image embeddings.

According to embodiments of the present invention, the system further comprises code for:

providing an image of a target Matthiola seed, computing the embedding of the target Matthiola seed by the at least one neural network, and

clustering the plurality of image embeddings and the embedding of the target Matthiola seed, and selecting a cluster that includes the embedding of the target Matthiola seed, wherein the instructions for execution by the sorting controller comprise instructions for selecting Matthiola seeds corresponding to the selected cluster.

According to embodiments of the present invention, the automated sorting of Matthiola seeds comprises discarding the single flowering Matthiola seeds.

According to embodiments of the present invention, the plurality of seeds weighs more than 10 grams.

According to embodiments of the present invention, the Matthiola seeds are of the species Matthiola incana.

According to embodiments of the present invention, the Matthiola incana seeds are of the Iron series.

According to embodiments of the present invention, there is provided a method of generating Matthiola seedlings by growing the Matthiola seeds classified into the specific classification category.

According to embodiments of the present invention, there is provided a method of plant generation by planting growing the Matthiola seeds classified into the specific classification category.

According to embodiments of the present invention, there is provided a method of growing a cut of Matthiola plants by growing the Matthiola seeds classified into the specific classification category, and cutting the plants when grown.

According to embodiments of the present invention, there is provided a method of manufacturing Matthiola seedlings by growing the Matthiola seeds classified into the specific classification category.

According to embodiments of the present invention, there is provided a container comprising a plurality of Matthiola seedlings, wherein at least a target percentage of the seedlings is of a specific classification category.

According to embodiments of the present invention, there is provided a method of producing a container of a plurality of Matthiola seedlings, comprising growing the Matthiola seeds classified into the specific classification category, into Matthiola and seedlings, and placing the Matthiola seedlings into the container.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is flowchart of a process for sorting seeds according to images of the seeds, in accordance with some embodiments of the present invention;

FIG. 2 is a block diagram of components of a system for classifying and/or clustering seeds according to images of the seeds, and/or for training neural networks for classifying and/or clustering the images of the seeds, in accordance with some embodiments of the present invention;

FIG. 3 is a flowchart of a process for training one or more neural networks for computing classification categories and/or embeddings according to seed images, in accordance with some embodiments of the present invention;

FIGS. 4A-4E are dataflow diagrams of exemplary dataflows based on the methods described with reference to FIGS. 1 and/or 3, executable by components of system 200 described with reference to FIG. 2, in accordance with some embodiments of the present invention;

FIG. 5 is a flowchart depicting a high level process of generating a neural network that classifiers an image depicting a Matthiola seed into single flowering or double flowering, in accordance with some embodiments of the present invention; and

FIG. 6 includes images of Matthiola seeds and corresponding grown plants of the single flowering and double flowering types, in accordance with some embodiments of the present invention.

### DESCRIPTION OF SPECIFIC EMBODIMENTS OF THE INVENTION

The present invention, in some embodiments thereof, relates to a method of distinguishing between a single flower phenotype and a double flower phenotype of Matthiola seeds and, more particularly, but not exclusively, to Matthiola incana seeds.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Traditional plant breeding and selection techniques have identified Matthiola incana varieties in which a double flowering phenotype and a single flowering phenotype is evident in a 50:50 ratio. Furthermore, many modern strains produce doubles in even higher proportions—up to about 92%.

Whilst reducing the present invention to practice, the present inventors have now uncovered that Matthiola incana seeds can be sorted according to the single/double flowering phenotype using a machine learning algorithm.

As is illustrated hereinunder and in the examples section, which follows, the present inventors show Matthiola incana seeds of different varieties, representing different genetic background and different flower colors, can be sorted according to their flowering phenotype with a very high degree of accuracy.

An aspect of some embodiments of the present invention relates to systems, methods, an apparatus, and/or code instructions for automated classification of Matthiola seeds into a single flowering classification category or into a double flowering classification category, and optionally automated sorting of the Matthiola seeds according to the classification. The classification of seeds may refer to clustering of embeddings of images of Matthiola seeds (e.g., extracted from hidden layers of a neural network) into clusters of single flowering and double flowering. Images, each one including one or more seeds, are inputted into one or more neural networks. Optionally, images are segmented such that each image includes a single seed. The neural network(s) compute an indication of the classification i.e., single flowering or double flowering, for each Matthiola seed depicted in the image(s), at least according to weights and/or architecture of the trained neural network. In some implementations, traditional features such as visual features based on one or more physical properties of the seeds are not explicitly defined for extraction by the neural network described herein. Such traditional (e.g., visual) features may be identified automatically by the neural network during training in an implicit manner, for example, implied by the weights and/or architecture of the neural network. However, the neural network is not explicitly programmed to explicitly extract defined visual features. In contrast, such traditional features are explicitly defined and extracted from the images by non-neural network statistical classifiers, for example, linear classifiers, support vector machines, k-nearest neighbors, and decision trees. Even when neural networks are used in existing approaches, images of seeds used to train the neural network and images of seeds fed into the neural network for inference have distinct visual indications therein, for example, a distinct region of the seed is colored due to a DNA marker inserted into the seed. Examples of visual features based on one or more physical properties of the seed extracted from images of the seed(s) by non-neural network statistical classifiers, include, hand-crafted features, size dimension(s) of the seed, color of the seed, shape of the seed, texture of the seed, combinations of the aforementioned, and the like. The trained non-neural network statistical classifiers cannot compute the classification category (i.e., single flowering or double flowering) for the seed with statistical significance (i.e., the non-neural network computes the classification category with statistical insignificance, for example, the probability indicating accuracy of the classification result performed by the non-neural network statistical classifier is below a predefined threshold (e.g., below about 20%, or 50%, or 70%, or 90%, or other values), for example practically irrelevant for physical sorting of the seeds due to the inaccuracy of the classification) according to the extracted explicitly defined visual features alone when the seeds are similar visually and/or have similar physical characteristics. For example, when the image includes two or more seeds which are very similar visually and/or physically to one another, the trained neural network described herein is able to classify (with statistical significance, e.g., above a threshold) the images of the seeds into different classification categories (i.e. single flowering/double flowering) according to weights of neurons of the trained neural network. In contrast, the trained non-neural network statistical classifier cannot classify the images of the seeds into these two different classification categories with statistical significance based on the extracted visual features. For example, the non-neural network statistical classifier may classify the images of the seeds into the same classification category according to the extracted visual features. Visual feature(s) extracted from one image of one seed are statistically similar (e.g., within a tolerance threshold) to corresponding visual feature(s) extracted from another image of another seed when the seeds are visually and/or physically similar. For example, the seeds are of the same size and/or same color and/or same texture. The classification performed by the trained neural network described herein is at least according to the categories single flowering and double flowering that represent differences between the seeds for which visual features are not explicitly defined. It is noted that in some implementations, the neural network may extract and use such traditional visual features along with non-traditional and even non-explained, specialized feature. Such non-traditional and non-explained specialized features are automatically learned by the neural network but cannot be learned and/or extracted by non-neural network statistical classifiers. Instructions for execution by a sorting controller of an automated sorting device may be created according to the computed indication of classification categories. For example, the Matthiola seeds are sorted according to classification categories single flowering and double flowering, such that seeds of a same sorted cluster have the same classification category.

The neural network described herein computes the classification categories of single flowering and double flowering with relatively higher accuracy and/or higher statistical certainty in comparison to non-neural network statistical classifiers that extract explicitly defined visual features.

Seeds are sorted according to clusters and/or embeddings based on output of the neural network described herein, with relatively higher accuracy and/or higher statistical certainty in comparison to non-neural network statistical classifiers that extract explicitly defined visual features.

Inventors discovered that neural networks, trained on images of seeds that are visually and/or physically indistinguishable to humans and/or to non-neural network statistical classifiers extracting explicitly defined visual features (e.g., size, shape, color, texture), are able to differentiate between the seed images (e.g., compute classification categories thereof and/or create clusters) according to predicted classification categories, i.e., single flowering and double flowering. Inventors discovered that during training, the neural network automatically computes its weights, which enable the neural network to automatically learn and/or discover previously unknown features and/or features which are not necessarily directly correlated to visual and/or physical properties of the seeds. Such automatically discovered features, which are not available to non-neural network statistical classifiers, enable the neural network to differentiate between images of seeds that are otherwise visually and/or physically similar Experimental support of inventor's discovery is provided in the “Examples” section below.

Optionally, the image includes multiple seeds that are different from one another within a tolerance range by a single feature that is not explicitly expressed visually and/or physically by the seed, i.e., predicted phenotype of single flowering or double flowering. The single feature cannot be extracted only according to visual feature(s) extracted by non-neural network statistical classifiers. For seeds that are similar visually and/or physically, the non-neural network statistical classifiers classify the images of the multiple seeds into a same classification category, and/or cannot classify the images of the seeds (e.g., output error or statistically insignificant category, since the single feature cannot be extracted only by the at least one visual features). The images of the seeds may be clustered according to the classification categories and/or embeddings outputted by the neural network. The instructions for sorting are generated according to the clusters, to sort the seeds according to the clusters.

Optionally, visual features that are extracted (or extractable) from the images depicting the Matthiola seeds include only statistically similar extractable features, for example, the Matthiola seeds are of statistically similar shapes, colors, and sizes. Optionally, visual features that are extracted (or extractable) from the images depicting the Matthiola seeds exclude non-statistically similar extractable visual features, for example, the Matthiola seeds do not significantly differ from one another in terms of features such as size, shape, and color.

Optionally, non-statistically similar visual features (i.e., statistically different visual features) extracted from the plurality of Matthiola seeds depicted image(s) are non-correlated with the classification categories of single flowering and double flowering. The non-statistically similar visual features may include a segmented visual marker that is non-correlated with single flowering and double flowering. For example, the Matthiola seeds may be of different colors, shapes, and/or sizes, where the color, shape, and/or size are not correlated with whether the seeds are of single flowering or double flowering phenotypes. In another example, the Matthiola seeds are not genetically engineered to display a segmentable visual marker linked to the single or double flowering phenotype to enable visually distinguishing between the single or double flowering. For example, Matthiola seeds are not genetically engineered to display one colored region (which is visually segmentable from the image) for single flowering, and another colored region of different color for double flowering. Since not such visual marker linked to the single or double flowering phenotype is used, no such visual marker may be extracted from the images and used for classification.

Optionally, the seeds cannot be differentiated from one another based on manual visual observation, and/or based on visual features such as size and color.

According to a specific embodiment, the visual feature extracted from the plurality of Matthiola seeds is not based on the color of the seeds (e.g. is extracted without computing color tone and/or without using different color channels). Thus, for example, the extraction is carried out whereby the color of the two different batches of seeds are statistically similar

Optionally, the seeds are differentiated from one another by planting the seeds, waiting for growth to occur sufficiently to differential visible features of the growth as single flowering or double flowering.

Optionally, the seeds cannot be differentiated from one another by a non-neural network statistical classifier only according to extracted visual features based on physical characteristics, for example, size, color, texture, hand drafted feature, shape, and a segmentable visual marker such as due to genetically engineered DNA sequences that trigger different visual markers in single and double flowering seeds.

Optionally, the seeds are grown under the same (or similar) environmental conditions, such as during the same growing season, at the same geographical location (e.g., same field, same greenhouse) and/or the same temperature.

Optionally, the images corresponding to the seeds are classified according to classification categories that are determined during a training phase for training the neural network. The training is performed using images of intact (and preferably viable) training seeds. The seeds are planted until there is sufficient growth to enable differentiating between single flowering and double flowering. The images of the seeds (i.e., before being planted) are then labelled with the indication of single flowering or double flowering. The neural network is trained on the images of Matthiola seeds labelled with single flowering and double flowering labels. New images of seeds are classified into single flowering and double flowering by the trained neural network trained on images of the training seeds, which allows determining the single flowering and double flowering from the image without needing to plan the seed first.

At least some of the systems, methods, apparatus, and/or code instructions described herein address the technical problem of sorting Matthiola seeds into double flowering phenotype or single flowering phenotype. Generally, the double flowering phenotype is desirable while the single flowering is not desired. Current practice for separation of Matthiola seeds of Japanese and European stock varieties according to double and single flower phenotype is performed manually after seed germination at the nursery which is an error-prone, or at the field by planting the seeds until a flowering stage is reached. Such existing approaches are time-consuming, labor intensive, and not cost effective task. At least some of the systems, methods, apparatus, and/or code instructions described herein address the above mentioned technical problem, and/or improve over the existing process of manual sorting based on germinated seeds and/or planted seeds at the flowering stage, by using images of the Matthiola seeds, prior to seed germination and prior to the flowering stage, and without planting of the seeds. The images of Matthiola seeds for which the phenotype of single or double flowering is unknown, and cannot be determined using existing approaches since the seeds have not yet been germinated and have not been planted and not reached the flowering stage, are fed into a neural network trained on labelled images of Matthiola seeds. The neural network infers the classification category of single or double flowering for seeds depicted in the images, optionally only from the images, without requiring germination of the seeds and/or planting of the seeds to reach the flowering stage. Inventors discovered that a neural network, trained on labelled images of Matthiola seeds, is able to accurately infer the single or double flowering phenotype on new images of Matthiola seeds for which the single or double flowering phenotype is unknown and cannot be determined using manual methods (i.e., when the seeds are pre-germinated and non-planted and do not express the flowering stage.

At least some of the systems, methods, apparatus, and/or code instructions described herein improve the technical field of automated sorting of seeds. Traditional machines for sorting of seeds are based on physical properties of the seeds, for example, a gravity table that sorts seeds based on weights. Sorting machines based on optical methods still rely on visual properties of the seeds based on physical properties, for example, size, color, shape, and texture. Traditional sorting machines may indirectly ensure homogeneous physical properties of seeds (e.g., size, shape, color) by removing dirt, foreign materials, broken seeds, and misshapen seeds. None of the traditional sorting machines analyze seeds to categorize them into single flowering or double flowering.

At least some of the systems, methods, apparatus, and/or code instructions described herein improve the technical field of automated classification and/or automated sorting of seeds. The automated classification and/or automated sorting is not based on a simple coding of an existing manual process onto a computer. Rather, at least some systems, methods, apparatus, and/or code instructions described herein turn a subjective method into an objective, reproducible method based on the trained neural network code described herein. Inventors developed new steps that did not previously exist in the manual process, and do have not counterparts in the manual process, namely, training of the neural network code, and/or execution of the trained neural network code to automatically classify and/or cluster images of seeds. At least the trained neural network code described herein provides objective, reproducible classification and/or clustering results, which are not available using standard manual processes. Moreover, as described herein, in cases where the seeds are visually indistinguishable from each other to a user, the automated processes described herein are able to perform classification and/or clusterization which cannot be performed manually.

The term “seed” refers to a seed of the flowering plant of the genus Matthiola which is a complete self-contained reproductive unit. The seed typically consists of a zygotic embryo resulting from sexual fertilization or through asexual seed reproduction (apomixis), storage reserves of nutrients in structures referred to as cotyledons, endosperm or megagametophytes, and a protective seed coat encompassing the storage reserves and embryo.

The Matthiola seeds which are undergoing categorization according to embodiments of the present invention are typically viable—i.e. capable of germinating, although in some cases categorization of non-viable seeds is also contemplated, as further described herein below.

According to a particular embodiment, the seeds are of the Matthiola incana species.

The Matthiola incana seeds may be of any variety and of any genetic background,—e.g. Iron series; variety Iron Rose Pink, Iron Blue, Iron Deep Pink, Iron Rose, Iron White, Iron Marine, Iron Purple, Iron Pink, Iron Apricot, Iron Yellow, Iron Cherry Blossom; Iron early series; Iron early Deep Yellow, Iron early Rose Pink, Iron early Pink, Iron early Marine, Iron early White; Quartet series; Quartet Apricot improved, Quartet Cherry Blossom, Quartet Purple, Quartet Blue, Quartet White, Quartet Marine, Quartet Rose, Quartet Red II; Centum series; Centum Deep Blue, Centum Cream; New Kabuki series; New Kabuki Dark Lavender, New Kabuki Rose Pink; Katz series; Katz White, Katz Crimson, Katz Blue; Aida series; Aida White, Aida Blue; Revolution II White, Cheerful Yellow and Arrow White.

According to a particular embodiment, the Matthiola is a dried seed. The appropriate conditions (temperature, relative humidity, and time) for the drying process will vary depending on the seed and can be determined empirically (see, for example, Jeller et al. 2003. ibid).

The Matthiola of the present invention may also be a primed seed.

It will be appreciated that the system described herein is capable of categorizing a heterogeneous population or batch of seeds, a portion of which are of a single flowering phenotype and another portion being of a double flowering phenotype. The neural network may compute the classification category, and/or the embedding, and/or perform clustering, for sorting the heterogeneous population or batch of seeds based on one or more of the following heterogeneous indications, as described herein.

As used herein, the term “double flowering” refers to a characteristic where the number of petals per flower is increased compared to the number of petals in the wild-type simple flower species. In a particular embodiment, the term “double flowering” refers to the trait of having a flower within a flower. Double flowering typically results from conversion of stamens and carpels to petals and septals.

As used herein, the term classifying of seeds may sometimes be interchanged with the term clustering of seeds, for example, when multiple seed images are analyzed, each image may be classified and used to creating clusters, and/or the seed images may be embedded and the embeddings may be clustered. The term classification category may sometimes be interchanged with the term embedding, for example, the output of the trained neural network in response to an image of a seed may be one or more classification categories, or a vector storing a computed embedding. It is noted that the classification category and the embedding may be outputted by the same trained neural network, for example, the classification category is outputted by the last layer of the neural network, and the embedding is outputted by a hidden embedding layer of the neural network.

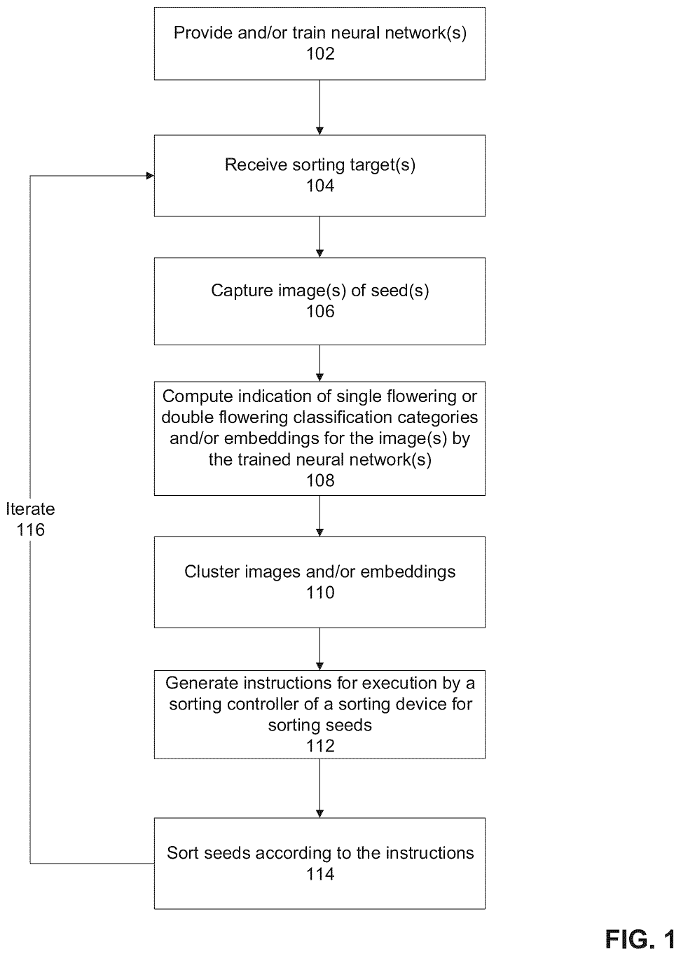

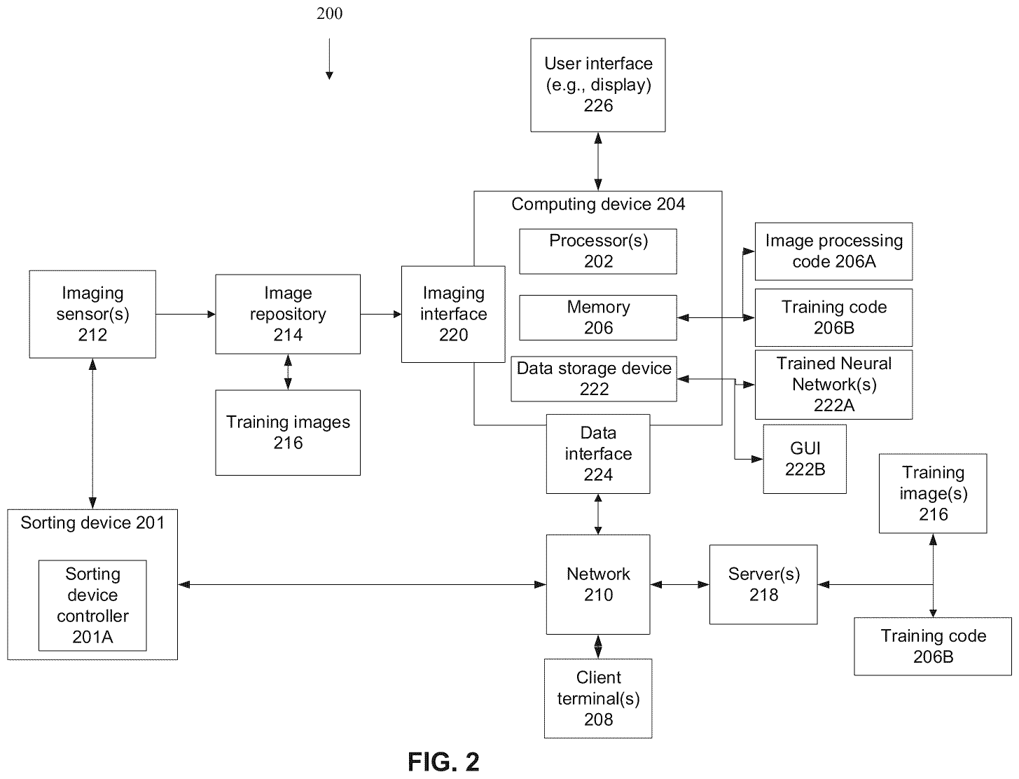

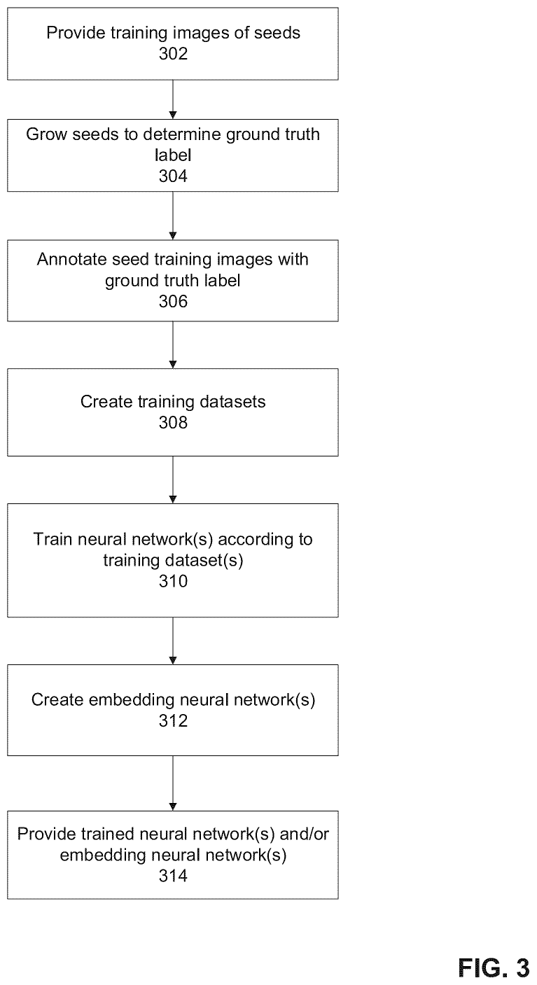

Reference is now made to FIG. 1, which is a flowchart of a process for sorting seeds according to images of the seeds, in accordance with some embodiments of the present invention. Reference is also made to FIG. 2, which is a block diagram of components of a system 200 for classifying and/or clustering seeds according to images of the seeds, and/or for training neural networks for classifying and/or clustering the images of the seeds, in accordance with some embodiments of the present invention. System 200 may generate code instructions according to the automated classification and/or clustering based on output of the trained neural network(s), that when executed by a sorting device controller 201A causes a sorting device 202 to automatically sort the seeds. Reference is also made to FIG. 3, which is a flowchart of a process for training one or more neural networks for computing classification categories and/or embeddings according to seed images, in accordance with some embodiments of the present invention. System 200 may execute the acts of the method described with reference to FIG. 1 and/or FIG. 3, for example, by a hardware processor(s) 202 of a computing device 204 executing code 206A stored in a memory 206.

Sorting device 201 is designed to automatically, manually, and/or semi-automatically sort seeds. Sorting device 201 may be implemented, for example, as an assembly line of single seeds or groups of seeds that are sorted into different buckets. In another implementation, sorting device 201 may include a platform for storing seeds, and a robotic arm for selecting individual seeds for sorting. Sorting device 201 may include a mechanism for removal and/or disposal of certain seeds, for example, impure seeds.

Sorting device controller 201A may be implemented as, for example, a hardware processor(s) integrated within sorting device 201, an external computing device in communication with sorting device 201, and/or an external display that presents manual instructions for a user manually and/or semi-automatically operating sorting device 201.

Imaging sensor(s) 212 may be installed within and/or integrated with sorting device 201, for example, capturing images of the seeds for sorting by sorting device 201. Imaging sensor(s) 212 may be located externally and/or independently of sorting device 201, for example, for capturing images of seeds for creation of training images 216 for training the neural network(s) described herein.

Exemplary imaging sensor(s) 212 include: RGB (red, green, blue), multispectral, hyperspectral, visible light frequency range, near infrared (NIR) frequency range, infrared (IR) frequency range, and combinations of the aforementioned.

Computing device 204 may be implemented as, for example, a client terminal, a virtual machine, a server, a virtual server, a computing cloud, a mobile device, a desktop computer, a thin client, a kiosk, and a mobile device (e.g., a Smartphone, a Tablet computer, a laptop computer, a wearable computer, glasses computer, and a watch computer).

Multiple architectures of system 200 based on computing device 204 may be implemented. For example:
Computing device 204 may be integrated with sorting device 201 (i.e., controlled by controller 201A), for example, as a control console and/or control unit and/or instructions code stored within sorting device 201 for execution by a hardware processor(s) of the sorting device 201 (e.g., execution by controller 201A).
Computing device 204 may be implemented as a standalone device (e.g., kiosk, client terminal, smartphone, server) that includes locally stored code instructions 206A that implement one or more of the acts described with reference to FIG. 1. Computing device 204 is external to sorting device 201, and communicates with sorting device 201, for example, over a network, and/or by storing instructions on a data storage device that is then accessed by the controller 201A. The locally stored instructions may be obtained from another server, for example, by downloading the code over the network, and/or loading the code from a portable storage device.
Computing device 204 executing stored code instructions 206A, may be implemented as one or more servers (e.g., network server, web server, a computing cloud, a virtual server) that provides services (e.g., one or more of the acts described with reference to FIG. 1 to one or more client terminals 218 over a network 210. For example, providing software as a service (SaaS) to the client terminal(s) 218, providing software services accessible using a software interface (e.g., application programming interface (API), software development kit (SDK)), providing an application for local download to the client terminal(s) 218, providing an add-on to a web browser running on client terminal(s) 218, and/or providing functions using a remote access session to the client terminals 218, such as through a web browser executed by client terminal 218 accessing a web sited hosted by computing device 204. Each client terminal 208 may be associated with a respective sorting device and/or sorting device controller and/or imaging sensor 212, such that computing device 204 centrally generates instructions for sorting of seeds at respective remote sorting devices according to remotely acquired images.

It is noted that the training of the neural network(s), and the inference of the trained neural network(s) of images of seeds, may be implemented by the same computing device, and/or by different computing devices, for example, one computing device trains the neural network(s) and transmits the trained neural network(s) to another computing device acting as a server and/or provides the trained neural network(s) for local installation and execution for inference of the images.

Computing device 204 receives images of seeds (also referred to herein as seed images) captured by imaging sensor(s) 212. Seed images captured by imaging sensor(s) 212 may be stored in an image repository 214, for example, data storage device 222 of computing device 204, a storage server, a data storage device, a computing cloud, virtual memory, and a hard disk. Training images 216 may be created based on the captured seed images, as described herein.

Training images 216 are used to train the neural network(s), as described herein. It is noted that training images 216 may be stored by a server 218, accessibly by computing device 204 over network 210, for example, a customized training dataset created for training the neural network(s), as described herein. Server 218 may create the trained neural network(s) by executing training code 206B and using training image(s) 216, as described herein.

Computing device 204 may receive the training images 216 and/or seed images from imaging device 212 and/or image repository 214 using one or more imaging interfaces 220, for example, a wire connection (e.g., physical port), a wireless connection (e.g., antenna), a local bus, a port for connection of a data storage device, a network interface card, other physical interface implementations, and/or virtual interfaces (e.g., software interface, virtual private network (VPN) connection, application programming interface (API), software development kit (SDK)).

Hardware processor(s) 202 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 202 may include one or more processors (homogenous or heterogeneous), which may be arranged for parallel processing, as clusters and/or as one or more multi core processing units.

Memory 206 (also referred to herein as a program store, and/or data storage device) stores code instruction for execution by hardware processor(s) 202, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 206 stores code instructions for implementing trained neural network 222A. Memory 206 stores image processing code 206A that implements one or more acts and/or features of the method described with reference to FIG. 1, and/or training code 206B that executes one or more acts of the method described with reference to FIG. 3.

Computing device 204 may include a data storage device 222 for storing data, for example, one or more trained neural networks 222A (as described herein), and/or training images 216 and/or training datasets that include the training images (as described herein). Data storage device 222 may be implemented as, for example, a memory, a local hard-drive, a removable storage device, an optical disk, a storage device, and/or as a remote server and/or computing cloud (e.g., accessed over network 210). It is noted that trained neural network(s) 222A, and/or training images 216 may be stored in data storage device 222, with executing portions loaded into memory 206 for execution by processor(s) 202.

Computing device 204 may include data interface 224, optionally a network interface, for connecting to network 210, for example, one or more of, a network interface card, a wireless interface to connect to a wireless network, a physical interface for connecting to a cable for network connectivity, a virtual interface implemented in software, network communication software providing higher layers of network connectivity, and/or other implementations. Computing device 204 may access one or more remote servers 218 using network 210, for example, to download updated training images 216 and/or to download an updated version of image processing code 206A, training code 206B, and/or the trained neural network(s) 222A.

Computing device 204 may communicate using network 210 (or another communication channel, such as through a direct link (e.g., cable, wireless) and/or indirect link (e.g., via an intermediary computing device such as a server, and/or via a storage device) with one or more of:
Sorting device 201 and/or controller 201A, for providing the generated instructions for sorting and/or clustering seeds. The instructions may be code instructions for automatic operation of sorting device 201 when executed by controller 201A and/or manual instructions for manual operation of sorting device 201 and/or controller 201A and/or manual instructions for programming sorting device 201 and/or controller 201A.
Client terminal(s) 208, for example, when computing device 204 acts as a server providing image analysis services (e.g., SaaS) to remote sorting devices.
Server 218, for example, storing training images and/or obtaining trained neural networks.
Image repository 214 that stores training images 216 and/or seed images outputted by imaging sensor(s) 212.

It is noted that imaging interface 220 and data interface 224 may exist as two independent interfaces (e.g., two network ports), as two virtual interfaces on a common physical interface (e.g., virtual networks on a common network port), and/or integrated into a single interface (e.g., network interface).

Computing device 204 includes or is in communication with a user interface 226 that includes a mechanism designed for a user to enter data (e.g., select target sorting parameter, such as desired seed purity level, designate comparison seed) and/or view the computed analysis (e.g., seed classification categories, text based instructions for manual operation of the sorting device 201). Exemplary user interfaces 226 include, for example, one or more of, a touchscreen, a display, a keyboard, a mouse, and voice activated software using speakers and microphone.

Optionally, a GUI (Graphical User Interface) 222B (e.g., stored by data storage device 222 and/or memory 206 of computing device 204) is presented on a display implementation of user interface 226. GUI 222B may be used, to select the sorting target and/or view images of selected seeds and/or view instructions for manual operation of the sorting device.

Referring now back to FIG. 1, at 102, one or more neural networks are trained and/or trained neural networks are provided for classifying image(s) of each Matthiola seed into the single flowering or double flowering category.

The trained neural network(s) may be selected from multiple available trained neural networks. The selection may be performed manually by a user (e.g., via the GUI, for example, via a menu and/or icons of available neural networks). The selection may be performed automatically by code that analyzes, for example, the seed image, metadata of the seed image, obtains an indication of the hardware type of the imaging sensor(s), and/or obtains an indications of the type of seeds being imaged (e.g., from a database, from the sorting machine, from manual user entry). The selection may be according to the sorting target described with reference to act 104.

It is noted that act 102 and 104 may be integrated and executed as a single feature, executed in parallel, and/or act 104 may be executed before act 102.

The architecture of the neural network(s) may be implemented, for example, as convolutional, pooling, nonlinearity, encoder-decoder, recurrent, locally-connected, fully-connected layers, and/or combinations of the aforementioned.

The neural network(s) is trained according to a training dataset of training images. The training images depict category mixture of single flowering and double flowering Matthiola seeds. Each training image is associated with an indication of the classification category, and optionally whether the classification category is absent, for example, by a tag, metadata stored in association with the training image, and/or as a value stored in a database.

An exemplary method of training the neural network(s) is described with reference to FIG. 3.

At 104, one or more sorting targets are provided. The sorting targets may be manually entered by a user (e.g., via the GUI, for example, selected from a list of available sorting targets), obtained as predefined values stored in a data storage device, and/or automatically computed.

Exemplary sorting targets include:
No sorting target is provided. In such cases, seeds are clustered according to embeddings computed by the embedding layer of the neural network. The clusters include seeds most similar to one another. Clusters are created according to single flowering and double flowering indications.
An image of a target seed. The target seed may be a parent of the mix of seeds being analyzed. Other seeds determined to be similar to the target seed (e.g., having a statistical distance according to embedding of their images less than a threshold, as described with reference to act 110) may be clustered together. Providing the image of the seed enables selecting other similar seeds expected to have other similar classification categories without necessarily knowing how the desired plant obtained its traits. The target seed may be double flowering. Other double flowering seeds are identified for the target seed, or other single flowering seeds are identified for the target seed.
A target statistical distribution of classification categories. For example, 1:3 ratio of classification categories of single flowering and double flowering. The target statistical distribution may be obtained, for example, by planting the seeds and determining the distribution from the resulting growth. The target statistical distribution may be computed according to one or more provided target analysis values, for example, a target true positive, a target true negative, a target false positive, and a target false negative.

At 106, the image(s) of seed(s) are captured by the imaging sensor(s).

As used herein, the term target seed and target image (or target seed image) refer to the seed and image currently being analyzed and processed.

Exemplary imaging sensors include: RGB (red, green, blue), multispectral, hyperspectral, visible light frequency range, near infrared (NIR) frequency range, infrared (IR) frequency range, and combinations of the aforementioned.

One or more images of the seeds may be captured, for example, each image may be captured using a different imaging sensor, and/or at a different frequency. In another implementation, the image includes multiple channels, corresponding to different frequencies.

A single image may include multiple seeds, or a single image may include a single seed. Optionally, when the image includes multiple seeds, segmentation code is executed for segmenting each seed from the image, for example, based on color of seed versus background, based on computing a binary map, and/or based on edge detection. Sub-images, each including one seed may be created, where each sub-image is processed as described herein with reference to the seed image.

At 108, the target image(s) of the seed(s) are inputted into the trained neural network(s). Optionally, a single image of a single seed is processed, for example, sequentially. In some implementations, multiple images, each of a single seed, are processed in parallel.

The neural network(s) compute an indication of the single flowering or double flowering classification categories for the physical seed depicted in the image. The indication of the classification categories may be outputted, for example, by the last layer of the neural network, for example, a fully connected layer.

The neural network computes the classification category at least according to weights and/or architecture of the trained neural network. In some implementations, explicitly defined features (e.g., based on visual and/or physical properties of the seed, such as color, size, shape, texture) may be extracted and analyzed in addition to the features automatically extracted according to weights of the trained neural network. In contrast to non-neural network statistical classifiers which at least extract explicitly defined features indicative of visual and/or physical properties of the seeds, the trained neural network(s) does not necessarily extract such explicitly defined features. Although the neural network may implicitly learn such features during training, but unlike training for non-neural network statistical classifiers such visual and/or physical features are not explicitly defined for the neural network. For example, non-neural network statistical classifiers extract visual features based on one or more physical properties of the seed, for example, hand-crafted features, size dimension(s) of the seed, color of the seed, shape of the seed, texture of the seed, combinations of the aforementioned, and the like. For seeds that are visually and/or physically similar to one another, but differ in the trait of single flowering and double flowering, trained non-neural network statistical classifiers cannot compute the classification category for the seed with statistical significance (i.e., compute the classification category with statistical insignificance) based on explicitly defined visual and/or physical features, for example, classifying the seeds into the same classification category since the seeds have the same visual and/or physical features (within a tolerance requirement, e.g., threshold). Visual feature(s) extracted from one image of one seed are statistically similar (e.g., within the tolerance threshold) to corresponding visual feature(s) extracted from another image of another seed. In contrast, the neural network described herein is able to differentiate between the visually and/or physically similar seeds, to classify the seeds according to the difference trait.

The indication of the classification categories outputted by the trained neural network(s) may be an absolute classification category, and/or a probability of falling into the classification category.

The neural network(s) may compute an embedding for the seed image. The embedding may be stored as a vector of a predefined length. The embedding may be outputted by an embedding layer of the neural network, which may be the same neural network trained to output the classification category. The embedding layer may be an intermediate and/or hidden layer of the neural network trained to output the classification category. Layers after the embedding layer may be removed from the neural network, such that the embedded values are outputted by the embedding layer acting as the final layer.

Optionally, the classification category is determined according to an annotation of an identified embedded image that is similar to the embedding computed for the target seed image being analyzed. The embedded image may be obtained from the training dataset storing embeddings of the training images computed by the embedding layer of the trained neural network. The similar embedded image may be identified according to a requirement of a similarity distance between the embedding of the target image and the embedding of the training image. The similarity distance may be computed as a distance between a vector storing the embedding of the target image and each vectors each storing embedding of respective training images. Alternatively, the similarity distance is computed between the embedding of the target image and a cluster of embeddings of training images each associated with the same classification category. The distance may be computed to the center of the cluster, and/or edge of the cluster.

The similarity distance may be computed as the L2 norm distance. For example, the vector representation of embeddings of the training images that is closest (i.e., minimal distance) to the vector representation of the embedding of the target seed image is found. The classification category of the closest embedded training image is extracted and outputted as the classification category of the target seed.

At 110, multiple images (and/or embeddings thereof) of multiple seeds of different classification categories (and/or different embeddings) may be clustered. The images of the seeds are clustered into a single flowering cluster, or a double flowering cluster.

When multiple images are received, each of a single seed of a respective classification category, clusters are created according to the images, where images classified into the same classification category are in the same cluster. Alternatively or additionally, the images of the seeds are clustered according to the embeddings computed for each seed image. The vector representations of the embeddings may be clustered by clusterization code, for example, vectors closest together within an N-dimensional space (where N is the predefined vector length) are clustered together. Distances between images of the cluster may be computed as statistical distances between embeddings of the images computed by the embedding layer of the trained neural network, optional between vector representations of the embeddings, for example, L2 norm distances between the vector representations of the embeddings. The seeds may be physically clustered according to the created clusters by the sorting machine according to generated instructions for sorting the seeds corresponding to the clusters (e.g., as described with reference to act 112).

Optionally, the clusters are computed such that each embedded image member of each respective cluster is at least a threshold distance away from another cluster. Alternatively or additionally, the clusters are computed such that each embedded image member of each respective cluster is less than a threshold distance away from every other member of the same respective cluster. The threshold distance is selected, for example, to define the amount of tolerance of similarity between members of the cluster, and/or to define the amount of tolerance of difference between members of different clusters. Alternatively or additionally, an intra-cluster distance computed between embeddings of a same cluster is less than an inter-cluster distance computed between embeddings of different clusters. The distances between embeddings of the same cluster is less than the distance between one cluster to another cluster (e.g., distance between any embeddings of one cluster and any embeddings of another cluster) to prevent overlaps between clusters, and/or to ensure that members of the same cluster are more similar to one another than to members of another cluster.

Optionally, the clusterization is performed according to a target ratio of classification categories. Members of the clusters are arranged according to the target ratio. The target ratio may be provided with reference to act 104. For example, the target ratio may be for 95% double flowering seeds. The clusterization is performed such that 95% of the seeds identified as single flowering or double flowering are within the cluster, and the rest are excluded. For example, 95% of the embeddings of the images of the seeds that are closest together are selected for the cluster. In another example, the target ratio of the classification categories is computed according to a growth analysis of a sample of the seeds. For example, a sample of a large pool of seeds is sent for planting and growing to determine the percentage of single flowing and/or double flowering, which provides the result that the sample is 94% double flowering. The target ratio for clustering the rest of the seed pool is set to 94%. The remaining seeds are clustered according to their respective images to the target ratio without performing additional destructive testing.

Optionally, when the respective classification categories are single flowering and double flowering, the images are clustered into a seed cluster indicative of seeds classified as single flowering, or into a seed cluster indicative of seeds classified as double flowering. Optionally, the clusterization into the single flowering or double flowering is performed according to a target statistical distribution, which may be provided for example, as described with reference to act 104. The target statistical distribution may be computed according to one or more of the following (which may be provide, for example, as described with reference to act 104): a target true positive, a target true negative, a target false positive, a target false negative, a manually entered distribution, and a distribution measured according to growth test (where seeds are planted and grown) performed on a sample of the seeds. The threshold(s) for clustering (e.g., the encodings of the image, and/or a probability value associated with the classification category) is set according to the target statistical distribution.

Optionally, an indication of a ratio of classification categories is computed according to the training images stored by the training dataset.

Optionally, the clusterization is performed for seeds that are similar to one another, for example, seeds that are visually and/or physically similar to one another within a tolerance range, as described herein. Alternatively or additionally, the clusters of single flowering and double flowering categories are created for seeds that are grown under same environmental conditions. Alternatively or additionally, the clusters of single flowering and double flowering categories are created for seeds are grown at a same growing season. Alternatively or additionally, the clusters of single flowering and double flowering classification categories are created for seeds grown at a same geographical location. Alternatively or additionally, the clusters of single flowering and double flowering classification categories are created for seeds having identical physical parameters within a tolerance range. Exemplary physical parameters include one or a combination of: color, texture, size, area, length, roundness, width, thousand seed weight, and combinations of the aforementioned.

Optionally, embeddings are clustered into a new cluster when the embeddings are located above a distance threshold from another embedding which corresponds to a double flowering phenotype, and/or from a center of a cluster of embeddings which corresponds to a double flowering phenotype. The new cluster stores embeddings indicative of single flowering phenotype seeds. The single flowering seeds may be selectively removed from the seed lot by the sorting machine according to generated sorting instructions (e.g., as described with reference to act 112).

Alternatively, embeddings are clustered into a new cluster when the embeddings are located above a distance threshold from another embedding which corresponds to a single flowering phenotype, and/or from a center of a cluster of embeddings which corresponds to a single flowering phenotype. The new cluster stores embeddings indicative of double flowering phenotype seeds. The double flowering seeds may be selectively removed from the seed lot by the sorting machine according to generated sorting instructions (e.g., as described with reference to act 112).

Optionally, seeds corresponding to embeddings located a distance threshold from another embedding and/or a center of a cluster are denoted as being of a new sub-classification category are assigned a new sub-classification category, for example, color. The seeds of the new sub-classification category may be further sorted into the sub-classification categories, for example, seeds are sorted into combinations of single flowering and different colors, and/or double flowering and different colors. The distance threshold may include two thresholds. A first threshold indicative of completely abnormal seeds which may be defective and grow. Embeddings located far away from another embedding and/or from a cluster, above the first distance threshold, are indicative of abnormal seeds, for example, which are to be discarded. Embeddings located relatively closer, but still away from another embedding (i.e., indicative of normal and/or not abnormal seed, such indicating single flowering and/or double flowering) and/or from a cluster, above a second distance threshold, but below the first distance threshold, are indicative of a seed with new sub-classification category, for example, color, which are to be sorted according to colors. The images and/or embeddings identified as being associated with a new sub-classification category may be added to the training dataset for updating the trained neural network. For example, an indication of the new seed type may be presented on a GUI, and the user asked to manually enter the sub-classification category, such as color, after visually inspecting the result growth of the planted seed. Alternatively or additionally, the new sub-classification category is automatically computed according to the classification categories assigned to two or more image embeddings and/or two or more clusters in closest proximity to the embedding of the seed denoted as indicative of new sub-classification category. The new classification category may be computed based on the relative distances to the nearest image embeddings and/or clusters. For example, when the distance is split as 75% to the nearest cluster of double flowering seeds, and 25% to the nearest cluster of single flowering seeds, the new image and/or embedding is associated with a sub-classification category of a certain color of the double flowering phenotype.

Optionally, a certain seed is denoted as defective (or otherwise abnormal) when the embedding of the image of the certain seed is statistically different from all other clusters. The defective seed may be an entirely abnormal seed for which the single flowering/double flowering classification cannot be determined, or the defective seed may be a defective single flowering or double flowering seed. The statistical difference may be according to the value(s) of the embedding relative to the statistical value(s) computed for each cluster. Alternatively or additionally, the certain seed is assigned a certain classification category of a certain cluster when the embedding of the image of the certain seed is statistically similar to the cluster, optionally when one or more values computed for the embedding are similar to the statistical value(s) computed for the cluster. Exemplary statistical values computed for the cluster include: element wise mean of the embedding of the respective cluster (e.g., a mean vector representation where each element of the vector is the mean of corresponding values of the embeddings vectors of the cluster), variance of the embeddings of the respective cluster (e.g., element wise variance of the different vectors for the respective cluster), and higher moments of the embeddings of the respective cluster. For example, when the vector representation of the embedding is different than 99% of the vectors of all clusters, the embedding (and corresponding seed) is denoted as defective.

Optionally, when an image of a target seed is provided (e.g., as described with reference to act 104) in addition to a lot of mixed seeds, seeds that are similar to the target seed are selected from the lot. For example, when the target seed is double flowering, the double flowering seeds are selected from the lot. For example, when the target seed is single flowering, the single flowering seeds are selected from the lot. The image of the target seed is embedded by the neural network(s). A sub-set of image embeddings located less than a target distance threshold away from the embedding of the target seed are selected. The generated instructions for execution by the sorting controller include instructions for selecting seeds corresponding to the selected sub-set of the image embeddings. In another implementation, the image embeddings and the embedding of the target seed are clustered. The cluster that includes the target seed is selected. The instructions for execution by the sorting controller include instructions for selecting seeds out of the seed mix that correspond to the selected cluster.

At 112, instructions for execution by a sorting controller of a sorting device for sorting of the seeds are generated according to the indication of the classification category (or categories) and/or according to the created clusters (e.g., of the embeddings and/or images). The instructions are for sorting of the physical seeds corresponding to the analyzed seed images. The instructions are for physically sorting the seeds into single flowering and double flowering categories. Optionally, the instructions include instruction for discarding certain seeds, for example, seeds classified as defective (and/or for which no new sub-classification category is created).

The instructions may be, for example, for selecting certain seeds from a mix of seeds, for example, selecting the double flowering and leaving the single flowering, or selecting the single flowering and leaving the double flowering. The seeds may be arranged on a surface of a tray and/or platform. The physical location of each seed on the platform is mapped to the image of the seed, for example, to a segmented sub-portion of the image including multiple seeds on the platform. When each image of each seed is computed to determine its respective classification category and/or cluster, a robotic arm may select the seed according to the physical location mapped to the image. The robotic arm may then place each seed in a receptacle corresponding to the appropriate classification category and/or cluster.

In another implementation, the instructions may be for seeds arriving single file on a conveyor belt. Each seed may be imaged. An appropriate receptacle corresponding to the classification category and/or cluster of the image corresponding to the seed is positioned such that the seed enters the appropriate receptacle. For example, the conveyor belt is moved to the receptacle, or the appropriate receptacle is positioned at the end of the conveyor belt.

The instructions may be represented as code for automated execution by the controller, for example, as binary code, as a script, as human readable text, as source code, as compiled code, and/or as function calls. Alternatively or additionally, the instructions may be formatted for manual execution by a user, for example, the user manually programs the sorting machine based on the instructions. For example, the instructions are presented on a display (e.g., as text, as a movie, and/or as graphical illustrations) and/or printed.

Optionally, the instructions are generated in real time, for example, for execution by a dynamic sorting machine into which seeds are fed (e.g., continuously, or periodically), imaged, and dynamically sorted in real time.

At 114, the seeds are sorted according to the computed classification categories and/or clusters. The sorting may be automatically performed by the sorting device directed by the sorting controller executing the generated sorting instructions.

At 116, one or more acts described with reference to blocks 104-114 are iterated. For example, the iterations may be performed for each image. Each image of each seed is independently analyzed to determine the corresponding classification category, and the seed is sorted according to the classification category. In another example, the iterations may be performed for multiple images of multiple seeds, such as a batch of a mixture of seeds. The images of individual seeds are analyzed together (e.g., in parallel, or sequentially with intermediate results being stored) for clustering the images (e.g., embeddings of the images). The seeds of the lot are sorted according to the clusters.

Referring now to FIG. 3, at 302, multiple training images of different seeds are provided. Optionally, the images are segmented such that each segmented image includes a single seed. The images may be acquired by different types of imaging sensors. The images include seeds of different classification categories, including both single flowering and double flowering phenotypes.

The images are of seeds in the non-germinated (i.e., pre-germinated) stage, and/or of seeds which are non-planted (i.e., have not yet been planted) and/or of seeds which are the non-flower stage (i.e., have not grown to reach the flower stage).

At 304, each seed is planted to obtain a respective ground truth label of single flowering or double flowering. The planting is done in an orderly manner, such that a mapping between each planted seed and the image of the seed prior to planting is known. For example, each image is tagged with a unique code, and a location where the seed is planted is tagged with the same unique code.

When the seeds have grown into the seedling stage and/or the growth from the seed has flowered, a visual inspection is done to identify whether the phenotype is single flower or double flowering. The visual inspection may be done manually and/or automatically (e.g., using a classifier trained using images of flowering plants depicting visual features indicating single flower or double flowering, labelled with the corresponding phenotype).

At 306, each training image of each Matthiola seed is annotated with the ground truth label of single flowering and double flowering classification category determined from the grown seedling and/or flowering growth of the planted seed depicted in the respective training image. The annotation may be performed manually by a user (e.g., via a GUI that presents the unique code of the image of the seed and accepts the classification category as input from the user, for example, by clicking on either a single flowering icon or a double flowering icon), and/or automatically obtained by code, for example, from a device that performs an automated analysis of the seed (e.g., analyzes images of the grown seeds after planting, where single versus double flowering is visually discernable using visual features).

At 308, one or more training datasets are created based on training images and associated ground truth labels indicating the classification categories of single flowering or double flowering. The training datasets may be defined according to target neural networks, for example, according to type of imaging sensor.

At 310, one or more neural networks are trained according to the training dataset(s). The neural networks are trained for computing an indication of classification categories according to a target image of a seed captured by an imaging sensor.

Optionally, existing neural networks are retrained and/or updated according to additional annotated training images, such as when new variant types are detected.

Neural network(s) may be trained according to a loss function. The loss function may be measured for the neural network output over the seed images, to estimate the measure of consent between the network outputs and the real labels of the seed images. An example of a loss function is softmax loss. An optimization process (e.g., stochastic gradient descent) may be used to minimize the loss function. The optimization process may be iterated until a stop condition is met.

At 312, one or more embedding neural networks may be created based on the trained neural networks. The embedding neural network may be created by selecting an inner hidden layer of the trained neural network as the embedding layer, and removing the layers after the embedding layer.

Optionally, existing embedding neural networks are retrained and/or updated according to additional annotated training images, such as when new variant types are detected.

At 314, the trained neural networks and/or embedding networks are provided, for example, stored by the computing device and/or provided to remote computing devices for local implementation. Optionally, the weights of the neural network are provided.

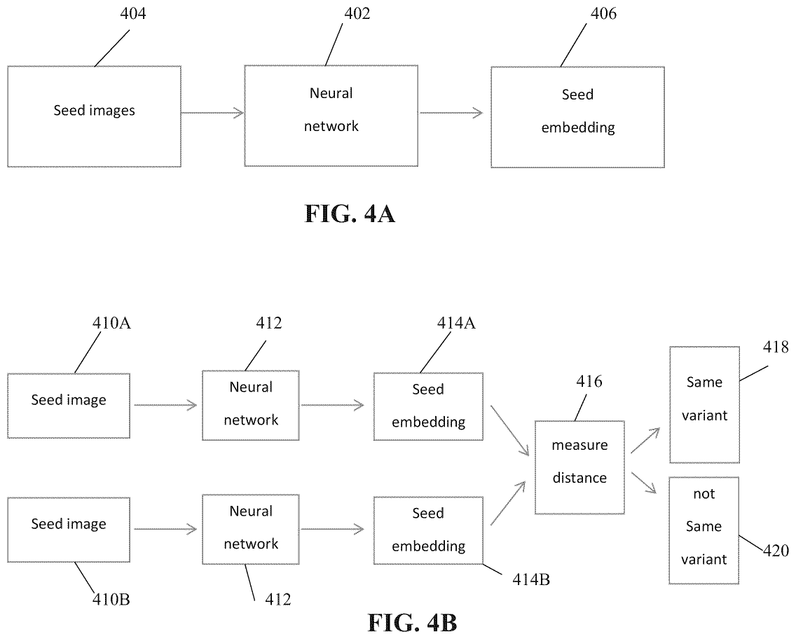

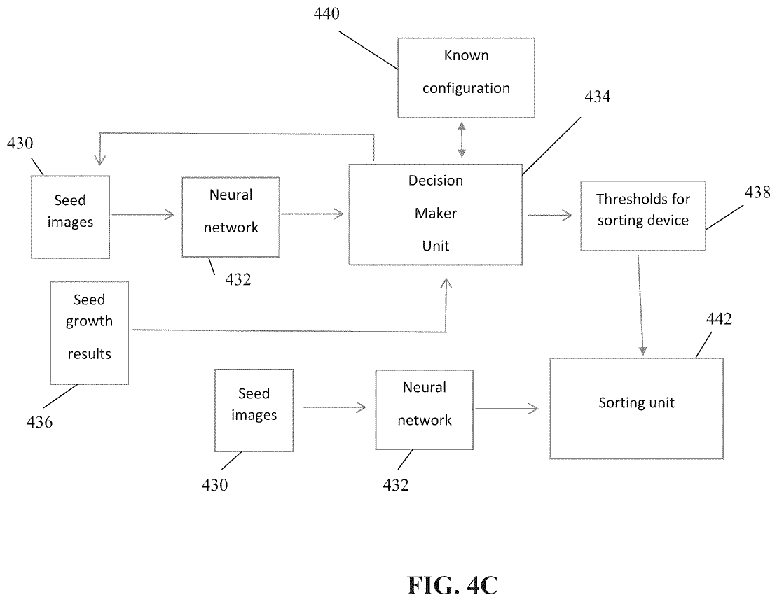

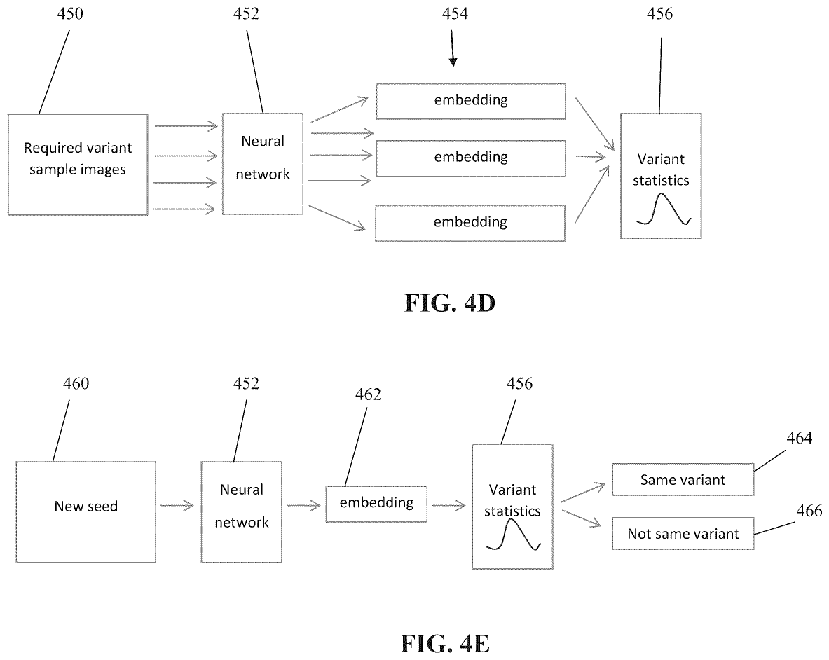

Reference is now made to FIGS. 4A-4E, which are dataflow diagrams of exemplary dataflows based on the methods described with reference to FIGS. 1 and/or 3, executable by components of system 200 described with reference to FIG. 2, in accordance with some embodiments of the present invention.

FIG. 4A depicts a dataflow for training an embedding neural network 402 according to training seed images 404 to compute embeddings of the seed images 406, in accordance with some embodiments of the present invention.

FIG. 4B depicts a dataflow for determining whether two seeds are of the same category (i.e., both double flowering, or both single flowering) or not. Seed images 410A-B of the two seeds are fed into a neural 412 for computation of respective embeddings 414A-B. A distance 416 between embeddings 414A-B is computed, for example, as the L2 norm distance between vector representations of the embeddings. The determination of whether the seeds are of a same category 418 or of different category 420 is made according to the distance 416, for example, when the distance is below a threshold the seeds are of same category 418, and of different category 420 when the distance is above the threshold.

FIG. 4C depicts a dataflow for improving purity results of seed batches according to seed growth where seeds are planted and grown to the seedling and/or flowering stage to determine the seed is of the single or double flowering phenotype. Seed images 430 are fed into a trained neural network 432, which outputs classification indications and/or embeddings into a decision-making unit 434. Decision making unit 434 receives as input seed growth results 436 of a sample of the seeds generated by a seed growth process where the seeds are planted and grown to the seedling and/or flowering stage to determine the seed is of the single or double flowering phenotype. Decision making unit 434 computes sorting thresholds 438 for sorting the seed images based on known statistical configurations 440. Decision making unit 434 provides sorting unit 442 with instructions of which seeds to discard and/or which seeds should remain to obtain the predetermined purity level. Sorting unit 434 may receive a mapping between the seeds for sorting and corresponding seed images 430 processed by neural network 432 for determining which seeds to remove and/or which seeds to leave.

FIG. 4D depicts a dataflow for defining statistics of a target seed single flowering or double flowering category. Multiple images for each of multiple target seed category 450 are fed into a neural network 452, which computes embeddings 454 for each image. Statistics 456 are computed for the embeddings, as described herein.

FIG. 4E depicts a dataflow for determining whether a target seed is of the same category as the seeds of FIG. 4D or not. An image 460 of the new target seed is fed into neural network 452 (of FIG. 4D) for computation of an embedding 462. The embedding is evaluated with category statistics 456 (computed as described with reference to FIG. 4D) to determine whether the new target seed is of a same category 464 as category samples 450 of FIG. 4D, or not of the same category 466.

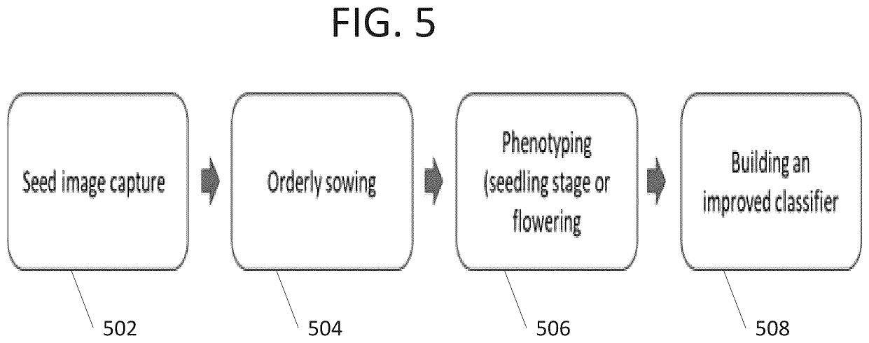

Reference is now made to FIG. 5, which is a flowchart depicting a high level process of generating a neural network that classifiers an image depicting a Matthiola seed into single flowering or double flowering, in accordance with some embodiments of the present invention. Features of FIG. 5 may correspond to, and/or be combined with, features described with reference to FIG. 3. At 502, images of Matthiola seeds are captured using an image sensor, optionally a camera. At 504, the Matthiola seeds are sowed. The location of each planted Matthiola seed is mapped to a respective image of the planted seed. At 506, the phenotype of single or double flowering is determined from the seedling and/or flowering of the sowed Matthiola seed. At 508, a neural network classifier is trained on a training dataset created by labelling the images of Matthiola seeds with a ground truth indication of the single or double flowering phenotype into which the sown seeds developed. The neural network classifier generates an outcome of single flowering or double flowering for a target image depicting a target Matthiola seed for which the phenotype is unknown, i.e., the Matthiola seed is new and not used in the training dataset.

It will be appreciated that following the categorization and sorting of the seeds according to the teachings of the present invention, it is contemplated that homogeneous populations of seeds can be obtained (i.e. seeds being of only a single flowering phenotype and seeds being of only a double flowering phenotype). The neural network may compute the classification category, and/or the embedding, and/or perform clustering, for sorting seeds according to the category of single flowering/double flowering, as described herein.

The neural network may compute the classification category, and/or the embedding, and/or perform clustering, for sorting statistically similar seeds, as described herein, with a relatively improved accuracy and/or improve statistical certainty in comparison to non-neural network statistical classifiers.

The homogeneous population of seeds may be such that at least 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, 99.991%, 99.992%, 99.993%, 99.994%, 99.995%, 99.996%, 99.997%, 99.998%, 99.999%, 99.9991%, 99.9992%, 99.9993%, 99.9994%, 99.9995%, 99.9996%, 99.9997%, 99.9998%, 99.9999% of the seeds are double flowering seeds.

The homogeneous population of seeds may be such that at least 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, 99.991%, 99.992%, 99.993%, 99.994%, 99.995%, 99.996%, 99.997%, 99.998%, 99.999%, 99.9991%, 99.9992%, 99.9993%, 99.9994%, 99.9995%, 99.9996%, 99.9997%, 99.9998%, 99.9999% of the seeds are single flowering seeds.

Thus, according to another aspect of the present invention there is provided a container or group of containers comprising a plurality of Matthiola seeds, wherein at least 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, 99.991%, 99.992%, 99.993%, 99.994%, 99.995%, 99.996%, 99.997%, 99.998%, 99.999%, 99.9991%, 99.9992%, 99.9993%, 99.9994%, 99.9995%, 99.9996%, 99.9997%, 99.9998%, 99.9999% of the seeds are of the seeds are double flowering Matthiola seeds.

Thus, according to another aspect of the present invention there is provided a container or group of containers comprising a plurality of Matthiola seeds, wherein at least 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, 99.991%, 99.992%, 99.993%, 99.994%, 99.995%, 99.996%, 99.997%, 99.998%, 99.999%, 99.9991%, 99.9992%, 99.9993%, 99.9994%, 99.9995%, 99.9996%, 99.9997%, 99.9998%, 99.9999% of the seeds are of the seeds are single flowering Matthiola seeds.

The container may be any vehicle that is capable of holding the seeds—such as a bag, a box, a sack or a crate.

The container may be labeled with a suitable label indicating the source of the seed and/or the purity of the batch (as measured according to embodiments of the present invention).

The container or group of containers typically comprises more than 100 seeds, more than 1000 seeds, more than 10,000 seeds, more than 100,000 seeds, more than 1,000,000 seeds, more than 10,000,000 seeds, or even more than 100,000,000 seeds.

The container may comprise seeds from a single plant or preferably more than one plant.

The weight of the homogeneous populations of seeds in the container or group of containers may vary from 10 grams, 50 grams, 100 grams, 500 grams, 1 kg, 10 kg, 20 kg, 50 kg, 100 kg 1 ton or more.

The present invention further comprises planting the seeds from the containers.

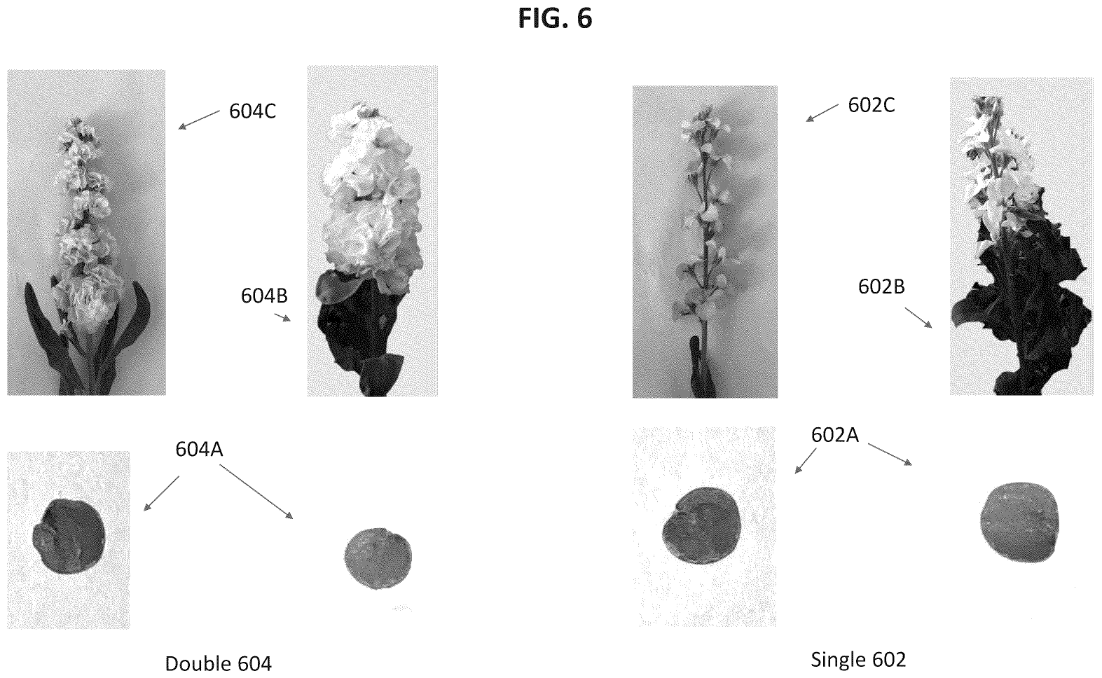

Reference is now made to FIG. 6, which includes images of Matthiola seeds and corresponding grown plants of the single flowering and double flowering types, in accordance with some embodiments of the present invention. Elements 602 depict images of seeds 602A and images of flowering plants 602B-C of the single flowering type. Elements 604 depict images of seeds 604A and images of flowering plants 604B-C of the double flowering type. Images 602B-C and 604B-C depict Matthiola incana plants of the Iron series, where image 602B depict Iron White single flowering, image 604B depicts Iron White double flowering, image 602C depicts Iron Marine single flowering, and image 604C depicts Iron Marine double flowering. When visually comparing seeds 602A which lead to single flowering plants 602B-C with seeds 604A which lead to double flowering plants 604B-C, it is apparent that seeds 602A and 604A are statistically visually similar, with no visually distinct marker (e.g., no extractable visual features, no segmentable and/or distinguishable marker) that enables differentiating between the two types of seeds. The trained neural network described herein is capable of accurately classifying images 602A and 604A into the single or double flowering classification categories, from which corresponding single and double flowering plants grow.

Thus, according to an aspect of some embodiments of the invention there is provided a method of growing a crop of Matthiola comprising seeding the homogenous population of seeds of the invention, thereby growing the crop.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Generally, the nomenclature used herein and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Maryland (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells—A Manual of Basic Technique” by Freshney, Wiley-Liss, N. Y. (1994), Third Edition; “Current Protocols in Immunology” Volumes I-III Coligan J. E., ed. (1994); Stites et al. (eds), “Basic and Clinical Immunology” (8th Edition), Appleton & Lange, Norwalk, C T (1994); Mishell and Shiigi (eds), “Selected Methods in Cellular Immunology”, W. H. Freeman and Co., New York (1980); available immunoassays are extensively described in the patent and scientific literature, see, for example, U.S. Pat. Nos. 3,791,932; 3,839,153; 3,850,752; 3,850,578; 3,853,987; 3,867,517; 3,879,262; 3,901,654; 3,935,074; 3,984,533; 3,996,345; 4,034,074; 4,098,876; 4,879,219; 5,011,771 and 5,281,521; “Oligonucleotide Synthesis” Gait, M. J., ed. (1984); “Nucleic Acid Hybridization” Hames, B. D., and Higgins S. J., eds. (1985); “Transcription and Translation” Hames, B. D., and Higgins S. J., eds. (1984); “Animal Cell Culture” Freshney, R. I., ed. (1986); “Immobilized Cells and Enzymes” IRL Press, (1986); “A Practical Guide to Molecular Cloning” Perbal, B., (1984) and “Methods in Enzymology” Vol. 1-317, Academic Press; “PCR Protocols: A Guide To Methods And Applications”, Academic Press, San Diego, C A (1990); Marshak et al., “Strategies for Protein Purification and Characterization—A Laboratory Course Manual” CSHL Press (1996); all of which are incorporated by reference as if fully set forth herein. Other general references are provided throughout this document. The procedures therein are believed to be well known in the art and are provided for the convenience of the reader. All the information contained therein is incorporated herein by reference.

### Double Flower Detection

### Materials and Methods

Seed samples: Samples of Matthiola seed varieties of Iron series; variety Iron Rose Pink, Iron Blue, Iron Deep Pink, Iron Rose, Iron White, Iron Marine, Iron Purple, Iron Pink, Iron Apricot, Iron Yellow, Iron Cherry Blossom; Quartet series; Quartet Blue, Quartet White; Centum series; Centum Deep Blue, Centum Cream; New Kabuki series; New Kabuki Dark Lavender, New Kabuki Rose Pink; Katz series; Katz White, Katz Crimson, Katz Blue; Aida series; Aida White, Aida Blue; Revolution II White, Cheerful Yellow and Arrow White. Each sample comprised of 1-4 different seed lots of a particular variety.

Image Acquisition and Analysis: Thousands of seeds from each sample were captured using different imaging sensors. Seeds were either sown and raised until full flower, or seedlings were analyzed on leaf samples using PCR markers distinguishing between single and double flowering individuals or were analyzed on seeds using PCR markers distinguishing between single and double flowering individuals, and the phenotypic data was loaded to train the system (FIG. 5).

For each sample, the images were split randomly into three groups, training (80%), validation (10%) and test (10%). This process was repeated 10 times for each line. A convolutional neural network was trained using the training set. The trained neural network was used to predict the seed phenotype for the validation and test sets images. For each seed image of these sets, the neural net outputs probabilities for the seed to belong to the trained double flower or single flower group. The group with the highest probability was selected. The percentage of correct predictions for each group was stored. This process was repeated 10 times with different random splits.

### Results

Using data obtained from different imaging sensors, the correct double or single flower of Matthiola seeds of different varieties representing different flower colors, was obtained.

For Centum Deep Blue, the double flower was improved from 0.45 to 0.73. For Centum Cream, the double flower was improved from 0.47 to 0.93. For Aida White, the double flower was improved from 0.49 to 0.94. For Aida Blue, the double flower was improved from 0.59 to 0.93. For Katz White, the double flower was improved from 0.59 to 0.90, for Katz Crimson, the double flower was improved from 0.50 to 0.90. For Quartet White, the double flower was improved from 0.57 to 0.95. For Quartet Blue, the double flower was improved from 0.53 to 0.95. For Revolution II White, the double flower was improved from 0.96 to 0.99. For New Kabuki Rose Pink, the double flower was improved from 0.54 to 0.85. For New Kabuki Dark Lavender, the double flower was improved from 0.50 to 0.85.

Using Seed-X sorting platform for image acquisition, and flowering phenotyping or PCR markers to validate the phenotypes, a set of classifiers was developed and the best classifier was selected for each variety. Classifier A was used to sort Iron Yellow, and the double flower was improved from 0.55 to 0.93. Classifier B was used for Iron Pink, and the double flower was improved from 0.55 to 0.94. For Iron Rose, the double flower was improved from 0.50 to 0.93. Classifier C was used to sort Iron White, and the double flower was improved from 0.52 to 0.92, Classifier D was used to sort Iron Deep Pink, and the double flower was improved from 0.54 to 0.92. Classifier E was used to sort Iron Purple, and the double flower was improved from 0.52 to 0.92. For Iron Blue, the double flower was improved from 0.53 to 0.86. Classifier F was used to sort Iron Cherry Blossom, the double flower was improved from 0.60 to 0.99. Classifier G was used to sort Iron Marine, the double flower was improved from 0.47 to 0.94.

The developed classifiers produced for the Iron White and for Iron Marine were used to sort respectively one and two seeds lots of each variety. The sorted seeds were raised as seedlings at a specialized plant nursery, without any selection and transplanted in the field at a specialized grower. No selection occurred during the whole crop cycle. For Iron white, Lot 56027-D3; grown 2.300 plants, of which 6.22% (143) plants were classified as single flowering and 93.78% (2,157) plants classified as double flowering. For Iron Marine Lot D1 (on which the Classifier was developed); grown 871 plants, of which 5.86% (51) plants were classified as single flowering and 94.14% (820) plants classified as double flowering. For Lot D2 (a different lot to the lot on which the classifier was developed); grown 591 plants, of which 5.58% (33) plants were classified as single flowering and 94.42% (558) plants classified as double flowering.

In another experiment, two seed lots of Iron White Matthiola were taken. Training was performed on the first lot, whilst prediction was carried out on the second lot. The double flower was improved from 0.50 to 0.90.

TABLE 1
flower phenotyping

| | | % Doubleniss | | | | | | |
|---|---|---|---|---|---|---|---|---|
| | | original non | | | Plants | | Plants | Plants |
| | | selected seeds | | Plants | Single | | Double | Double |
| | Seed lot | based on | | total | flowering | Plants | flowering | flowering |
| Variety | Indentification | PCR markers | Classifier | # | # | % | # | % |
| Iron Marine | 10525 | 56.3% | E | 321 | 25 | 7.8% | 296 | 92.2% |
| Iron Yellow | 10552 | 55.2% | A | 407 | 29 | 7.1% | 378 | 92.9% |
| Iron Blue | 10487 | 52.7% | E | 475 | 66 | 13.9% | 409 | 86.1% |

TABLE 2
seed phenotyping. via PCR markers

| | | % Doubleniss | | | | | | |
|---|---|---|---|---|---|---|---|---|
| | | original non | | | Seeds | | Seeds | Seeds |
| | | selected seeds | | Seeds | Single | | Double | Double |
| | Seed lot | based on | | total | flowering | Seeds | flowering | flowering |
| Variety | Indentification | PCR markers | Classifier | # | # | % | # | % |
| Iron White | 10518 | 52.0% | C | 382 | 31 | 8.1% | 351 | 91.9% |
| Iron White | 11128 | 55.9% | H | 256 | 28 | 10.9% | 228 | 89.1% |
| Iron Yellow | 10552 | 55.2% | B | 369 | 41 | 11.1% | 328 | 88.9% |
| Iron Cherry Blossom | 11124 | 59.6% | F | 347 | 2 | 0.6% | 345 | 99.4% |
| Iron Cherry Blossom | 11126 | 62.5% | F | 344 | 4 | 1.2% | 340 | 98.8% |
| Iron Pink | 10536 | 55.3% | B | 333 | 21 | 6.3% | 312 | 93.7% |
| Iron Deep Pink | 10509 | 54.0% | D | 334 | 26 | 7.8% | 308 | 92.2% |
| Iron Rose | 10513 | 50.0% | B | 367 | 26 | 7.1% | 341 | 92.9% |
| Iron Marine | 11129 | 47.0% | G | 169 | 10 | 5.9% | 159 | 94.1% |
| Iron Purple | 11136 | 51.9% | E | 179 | 14 | 7.8% | 165 | 92.2% |
| Iron Blue | 10487 | 52.7% | E | 367 | 59 | 16.1% | 308 | 83.9% |
| Iron Rose Pink | 10482 | 54.1% | I | 384 | 53 | 13.8% | 331 | 86.2% |

The results of the experiments performed on the Iron varieties are summarized in Tables 1 and 2.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for sorting of Matthiola seeds, comprising:
at least one hardware processor executing a code for:
feeding into at least one neural network, at least one image depicting a plurality of Matthiola seeds which have statistically similar extractable at least one visual feature, the at least one image captured by at least one imaging sensor,
wherein the at least one visual feature extracted from an image of one of the plurality of Matthiola seeds are statistically similar to corresponding at least one visual feature extracted from another image of another Matthiola seed of the plurality of Matthiola seeds,
computing by the at least one neural network, an indication of one classification category for which visual features are not explicitly defined, for each of the plurality of Matthiola seeds selected from the group consisting of: single flowering, and double flowering,
wherein the indication of at least one classification category is computed at least according to weights of the at least one neural network,
wherein the at least one neural network classifies the plurality of Matthiola seeds which have similar extractable at least one visual feature into one classification category selected from the group consisting of: flowering, and double flowering for which visual features are not explicitly defined,
wherein the at least one neural network is trained using a training dataset comprising a plurality of training images of a plurality of Matthiola seeds which have statistically similar extractable at least one visual feature captured by the at least one imaging sensor, each Matthiola seed of each training image labelled with a respective classification category for which visual features are not explicitly defined selected from the group consisting of: single flowering and double flowering; and
generating according to the indication of at least one classification category selected from the group consisting of: single flowering and double flowering, instructions for execution by a sorting controller of an automated sorting device for automated sorting of Matthiola seeds.

2. The system according to claim 1, wherein visual features extracted from the plurality of Matthiola seeds depicted in the at least one image include only statistically similar extractable features and exclude non-statistically similar extractable visual features.

3. The system according to claim 1, wherein non-statistically similar visual features extracted from the plurality of Matthiola seeds depicted in the at least one image are non-correlated with the classification category outcome of the at least one neural network selected from the group consisting of: single flowering and double flowering, wherein the non-statistically similar visual features extracted from the plurality of Matthiola seeds depicted in the at least one image include a segmented visual marker, the segmented visual marker being non-correlated with the classification category selected from the group consisting of: single flowering and double flowering.

4. The system according to claim 1, wherein the similar extractable at least one visual feature is selected from the group consisting of: a hand-crafted feature, at least one size dimension of the at least one seed, color of the at least one seed, shape of the at least one seed, texture of the at least one seed, estimated measurement of the at least one seed, and segmented visual marker.

5. The system according to claim 1, wherein the at least one classification category is determined by at least one of: (i) a destructive test that destroys the respective Matthiola seed after the respective training image of the Matthiola seed is captured by the at least one imaging sensor, and by growing the respective seed after the respective training image of the Matthiola seed is captured by the at least one imaging sensor until the single flower or double flower is visually present.

6. The system according to claim 1, wherein the at least one neural network computes an embedding for the at least one image, and wherein the at least one classification category is determined according to an annotation of an identified at least one similar embedded image from the training dataset storing embeddings of training images, the at least one similar embedded image identified according to a requirement of a similarity distance between the embedding of the at least one image and embedding of the training images, and at least one member selected from the group consisting of: (i) wherein the embedding is computed by an internal layer of the trained at least one neural network selected as an embedding layer, (ii) wherein the embedding is stored as a vector of a predefined length, wherein the similarity distance is computed as a distance between a vector storing the embedding of the at least one image and a plurality of vectors each storing embedding of respective training images, and (iii) wherein the similarity distance is computed between the embedding of the at least one image and a cluster of embeddings of a plurality of training images each associated with a same at least one classification category.

7. The system according to claim 1, wherein the at least one image comprises a plurality of images including a plurality of Matthiola seeds, and further comprising code for clustering the plurality of images according to respective classification categories, wherein the instructions for execution by the sorting controller comprise instructions for sorting the Matthiola seeds corresponding to the plurality of images according to respective classification categories, wherein the clusterization is performed according to a target ratio of classification categories and/or a target statistical distribution, wherein members of the clusters are arranged according to the target ratio, the target ratio of classification categories is computed according to a DNA analysis of a sample of the Matthiola and/or seeds, or according to a growth outcome of planting and growing the sample of the Matthiola seeds.

8. The system according to claim 1, wherein the at least one image comprises a plurality of images including a plurality of Matthiola seeds of different classification categories, wherein the at least one neural network computes an embedding for each of the plurality of images, wherein the embedding of the plurality of images are clustered by clusterization code, and wherein the instructions for execution by the sorting controller comprise instructions for sorting the Matthiola seeds according to corresponding clusters.

9. The system according to claim 8, wherein the clusters are computed according to at least one member selected from the group consisting of:
(i) such that each embedded image member of each respective cluster is at least a threshold distance away from another cluster, and
(ii) wherein the clusters are computed such that each embedded image member of each respective cluster is less than a threshold distance away from every other member of the same respective cluster,
(iii) wherein an intra-cluster distance computed between embeddings of a same cluster is less than an inter-cluster distance computed between embeddings of different clusters.

10. The system according to claim 8, at least one of:
(i) wherein Matthiola seeds corresponding to embeddings located above a distance threshold from at least one of: another embedding, a cluster, and within a center of the cluster, are denoted as being of a certain color and clustered into a certain color cluster, wherein Matthiola seeds denoted as being of a certain color are assigned a new classification category or to a new sub-classification category of the existing category according to classification categories assigned to at least two image embeddings and/or at least two clusters in proximity to the embedding of the Matthiola seed denoted as being of a certain color, wherein the new classification category or new sub-classification of existing category is computed according to relative distances to the at least two image embeddings and/or at least two clusters in proximity to the embedding of the Matthiola seed denoted as being of a certain color,
(ii) wherein at least one statistical value is computed for each cluster, and wherein a certain Matthiola seed is denoted as being defective when the embedding of the image of the certain seed is statistically different from all other clusters,
(iii) wherein at least one statistical value is computed for each cluster, and wherein a certain seed is assigned a certain classification category of a certain cluster when the embedding of the image of the certain seed is statistically similar to at least one statistical value of the certain cluster.

11. The system according to claim 1, further comprising code for:
providing an image of a target Matthiola seed, computing the embedding of the target Matthiola seed by the at least one neural network, and
at least one of:
(i) selecting a sub-set of the plurality of image embeddings according to image embedding located less than a target distance threshold away from the embedding of the target Matthiola seed, wherein the instructions for execution by the sorting controller comprise instructions for selecting Matthiola seeds corresponding to the sub-set of the plurality of image embeddings, and
(ii) clustering the plurality of image embeddings and the embedding of the target Matthiola seed, and selecting a cluster that includes the embedding of the target Matthiola seed, wherein the instructions for execution by the sorting controller comprise instructions for selecting Matthiola seeds corresponding to the selected cluster.

12. The system according to claim 1, wherein said automated sorting of Matthiola seeds comprises discarding the single flowering Matthiola seeds.

13. A system for classification of Matthiola seeds, comprising:
at least one hardware processor executing a code for:
feeding into at least one neural network, at least one image depicting a plurality of Matthiola seeds which have statistically similar extractable at least one visual feature, the at least one image captured by at least one imaging sensor,
wherein the at least one visual feature extracted from an image of one of the plurality of Matthiola seeds are statistically similar to corresponding at least one visual feature extracted from another image of another Matthiola seed of the plurality of Matthiola seeds; and
computing by the at least one neural network, an indication of one classification category for which visual features are not explicitly defined, for each of the plurality of Matthiola seeds selected from the group consisting of: single flowering, and double flowering,
wherein the indication of at least one classification category is computed at least according to weights of the at least one neural network,
wherein the at least one neural network classifies the plurality of Matthiola seeds which have similar extractable at least one visual feature into one classification category selected from the group consisting of: flowering, and double flowering for which visual features are not explicitly defined,
wherein the at least one neural network is trained using a training dataset comprising a plurality of training images of a plurality of Matthiola seeds which have statistically similar extractable at least one visual feature captured by the at least one imaging sensor, each Matthiola seed of each training image labelled with a respective classification category for which visual features are not explicitly defined selected from the group consisting of: single flowering and double flowering.

14. A device for training at least one neural network for classification of Matthiola seeds for sorting thereof, comprising:
at least one hardware processor executing a code for:
accessing a plurality of training images of a plurality of Matthiola seeds which have statistically similar extractable at least one visual feature captured by at least one imaging sensor,
wherein the at least one visual feature extracted from an image of one of the plurality of Matthiola seeds are statistically similar to corresponding at least one visual feature extracted from another image of another Matthiola seed of the plurality of Matthiola seeds;
creating a training dataset by labeling each Matthiola seed of each training image with a respective classification category for which visual features are not explicitly defined selected from a group consisting of: single flowering and double flowering,
wherein each label is determined by growing the respective Matthiola seed after the respective training image of the Matthiola seed is captured by the at least one imaging sensor until the single flower or double flower is visually present; and
training at least one neural network using the training dataset, the at least one neural network trained for generating an outcome of an indication of one classification category for which visual features are not explicitly defined, selected from the group consisting of: single flowering and double flowering, in response to an input of at least one target image depicting at least one seed captured by at least one imaging sensor,
wherein the indication of at least one classification category of the at least one target image is computed at least according to weights of the at least one trained neural network,
wherein the at least one neural network classifies the plurality of Matthiola seeds which have similar extractable at least one visual feature into one classification category selected from the group consisting of: single flowering and double flowering, for which visual features are not explicitly defined.

15. A container comprising a plurality of Matthiola seeds, wherein at least 90% of the seeds are double flowering seeds or 90% of the seeds are single flowering seeds, and wherein said plurality of Matthiola seeds comprises more than 100 seeds.

16. A method of growing a crop comprising seeding the seeds of the container of claim 15, thereby growing the crop.

17. A method of classifying Matthiola seeds, comprising:
growing unclassified Matthiola seeds;
capturing at least one image of the Matthiola seeds; and
classifying respective the Matthiola seeds into a specific classification category selected from a plurality of classification categories according to an outcome of a trained neural network model fed with the at least one image.

18. A method of at least one of:
(i) generating Matthiola seedlings by growing the Matthiola seeds classified into the specific classification category according to the method of claim 17,
(ii) plant generation by planting growing the Matthiola seeds classified into the specific classification category according to the method of claim 17,
(iii) growing a cut of Matthiola plants by growing the Matthiola seeds classified into the specific classification category according to the method of claim 17, and cutting the plants when grown
(iv) manufacturing Matthiola seedlings by growing the Matthiola seeds classified into the specific classification category according to the method of claim 17, and
(v) producing a container of a plurality of Matthiola seedlings, comprising growing the Matthiola seeds classified into the specific classification category according to the method of claim 17, into Matthiola seedlings, and placing the Matthiola seedlings into the container.

19. A container comprising a plurality of Matthiola seedlings, wherein at least a target percentage of the seedlings is of a specific classification category classified using the method of claim 17.

20. A method of producing a population of Matthiola seeds enriched for a double flowers trait, the method comprising subjecting Matthiola seeds to the system of claim 12.
